(19) United States
(12) Patent Application Publication
(10) Pub. No.: US 2025/0019214 A1
(43) Pub. Date: Jan. 16, 2025

(54) CARGO HANDLING CONTROL DEVICE

(71) Applicant: KABUSHIKI KAISHA TOYOTA JIDOSHOKKI, Kariya-shi (JP)

(72) Inventors: Kenjiro NAGAI, Kariya-shi (JP); Shingo HATTORI, Kariya-shi (JP); Koki TAKEUE, Kariya-shi (JP)

(73) Assignee: KABUSHIKI KAISHA TOYOTA JIDOSHOKKI, Kariya-shi (JP)

(21) Appl. No.: 18/766,827

(22) Filed: Jul. 9, 2024

(30) Foreign Application Priority Data
Jul. 14, 2023 (JP) 2023-115849
Mar. 22, 2024 (JP) 2024-046944

(51) Int. Cl. B66F 9/06; B65G 1/04; B65G 1/137

(52) U.S. Cl. CPC B66F 9/063; B65G 1/0492; B65G 1/137; B65G 2201/0235

(57) ABSTRACT

A cargo handling control device includes a target detector detecting a cargo handling target, a position calculator calculating a position of the cargo handling target relative to a forklift truck, an approach controller control the forklift truck based on the position of the cargo handling so that the forklift truck approaches a cargo handling position corresponding to the cargo handling target, an approach determiner determining whether an approach of the forklift truck to the cargo handling position is successful based on the position of the cargo handling target, a cargo handling controller controlling the forklift truck so that the forklift truck performs cargo handling, and a re-approach controller controlling the forklift truck so that the forklift truck re-approaches the cargo handling position when the approach determiner determines that the approach of the forklift truck to the cargo handling position is unsuccessful.

### CROSS-REFERENCE TO RELATED APPLICATION

This application claims priority to Japanese Patent Application No. 2023-115849 filed on Jul. 14, 2023, and No. 2024-046944 filed on Mar. 22, 2024, the entire disclosure of which is incorporated herein by reference. The present disclosure relates to a cargo handling control device.

### BACKGROUND ART

As a conventional cargo handling control device, a technique disclosed in Japanese Patent Application Publication No. 2022-70559 has been known. When a forklift truck travels along a first path so as to cross an area where a transport target (target object) having cargo loaded on a pallet is positioned, the cargo handling control device of No. 2022-70559 detects the position and the state of the transport target by a sensor to sets a second path to a target position where the forklift truck is positioned at a specific position and a state relative to the transport target based on the position and the state of the transport target based on the position and the state of the transport target and causes the forklift truck to travel along the second path.

However, the above-mentioned conventional technique may have circumstances below. That is, although it is low probability, a detection of a position of a target object by a sensor may fail due to a detection error. If the detection of the position of the target object fails, the forklift truck is displaced relative to the target object even if the set path for the forklift truck is appropriate, so that unloading of the pallet may not be performed. In addition, errors in estimation of the self-position of the forklift truck and a guidance of the forklift truck may occur due to an obstacle, and the like. If the errors in the estimation of the self-position of the forklift truck and the guidance of the forklift truck occur, approach of the forklift truck to the target object fails and the forklift truck is displaced relative to the target object. As a result, there is a possibility that unloading of the pallet may not be performed.

The present disclosure is directed to providing a cargo handling control device capable of improving the success rate of cargo handling by a forklift truck.

### SUMMARY

In accordance with an aspect of the present disclosure, there is provided a cargo handling control device that moves a forklift truck from a start position to a cargo handling target and performs cargo handling, the cargo handling control device including: a target detector configured to detect the cargo handling target; a position calculator configured to calculate a position of the cargo handling target relative to the forklift truck based on a detection data by the target detector; an approach controller configured to control the forklift truck based on the position of the cargo handling target relative to the forklift truck calculated by the position calculator while the forklift truck is at the start position so that the forklift truck approaches a cargo handling position corresponding to the cargo handling target; an approach determiner configured to determine whether an approach of the forklift truck to the cargo handling position is successful based on the position of the cargo handling target relative to the forklift truck calculated by the position calculator when the forklift truck reaches the cargo handling position; a cargo handling controller configured to control the forklift truck so that the forklift truck performs cargo handling of the cargo handling target when the approach determiner determines that the approach of the forklift truck to the cargo handling position is successful, and a re-approach controller configured to control the forklift truck so that the forklift truck re-approaches the cargo handling position based on the position of the cargo handling target relative to the forklift truck calculated by the position calculator when the approach determiner determines that the approach of the forklift truck to the cargo handling position is unsuccessful.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating a forklift truck to which a cargo handling control device according to an embodiment of the present disclosure is applied;

FIG. 2 is a block diagram illustrating a configuration of a cargo handling control device according to a first embodiment of the present disclosure;

FIGS. 3A, 3B, and 3C are schematic plan views illustrating an operation of the forklift truck moving from a start position to a cargo handling position and performing unloading;

FIG. 4 is a flowchart of unloading control processing performed by a controller illustrated in FIG. 2;

FIG. 5 is a flowchart showing details of step S111 in FIG. 4;

FIGS. 6A, 6B, and 6C are schematic plan views illustrating the operation of the forklift truck retrying approach to the cargo handling position when the approach of the forklift truck to the cargo handling position is unsuccessful;

FIG. 7 is a block diagram illustrating a configuration of a cargo handling control device according to a second embodiment of the present disclosure;

FIG. 8 is a flowchart of unloading control processing performed by a controller illustrated in FIG. 7;

FIGS. 9A, 9B, and 9C are schematic plan views illustrating an operation of the forklift truck retrying approach to the cargo handling position when the approach of the forklift truck to the cargo handling position is unsuccessful;

FIG. 10 is a block diagram illustrating a configuration of a cargo handling control device according to a third embodiment of the present disclosure;

FIG. 11 is a flowchart of unloading control processing performed by a controller illustrated in FIG. 10;

FIGS. 12A, 12B, and 12C are schematic plan views illustrating an operation of the forklift truck retrying approach to the cargo handling position when the approach of the forklift truck to the cargo handling position is unsuccessful and an unloading target pallet is not detectable by a camera;

FIG. 13 is a block diagram illustrating a configuration of a cargo handling control device according to a fourth embodiment of the present disclosure;

FIG. 14 is a flowchart of unloading control processing performed by a controller illustrated in FIG. 13;

FIGS. 15A, 15B, and 15C are schematic plan views illustrating an operation of the forklift truck moving from a start position to a cargo handling position and performing unloading;

FIGS. 16A, 16B, and 16C are schematic plan views illustrating the operation of the forklift truck retrying approach to the cargo handling position when the approach of the forklift truck to the cargo handling position is unsuccessful and an unloading target pallet is not detectable by a camera;

FIGS. 17A, 17B, and 17C are schematic plan views illustrating the operation of the forklift truck retrying approach to the cargo handling position when the approach of the forklift truck to the cargo handling position is unsuccessful and an unloading target pallet is not detectable by a camera;

FIG. 18 is a block diagram illustrating a configuration of a cargo handling control device according to a fifth embodiment of the present disclosure;

FIG. 19 is a flowchart of unloading control processing performed by a controller illustrated in FIG. 18;

FIGS. 20A and 20B are views, including a plan view and a front view, illustrating an example of a situation where a success rate of unloading is increased by retrying the approach of the forklift truck, and an example of a situation where the success rate of unloading is not increased by retrying the approach of the forklift truck;

FIG. 21 is a flowchart showing details of steps S111 and S131 shown in FIG. 19;

FIGS. 22A, 22B, 22C, and 22D are views, including a plan view, a front view, and a cross-sectional view, illustrating states where the approach of the forklift truck to the cargo handling position is unsuccessful; and

FIGS. 23A and 23B are perspective views illustrating dimensions of fork holes of the pallet and forks.

### DETAILED DESCRIPTION OF THE EMBODIMENTS

The following will describe an embodiment of the present disclosure in detail with reference to the accompanying drawings. It is to be noted that, in the drawings, identical or equivalent elements are denoted by the same reference numerals, and description thereof will not be repeated.

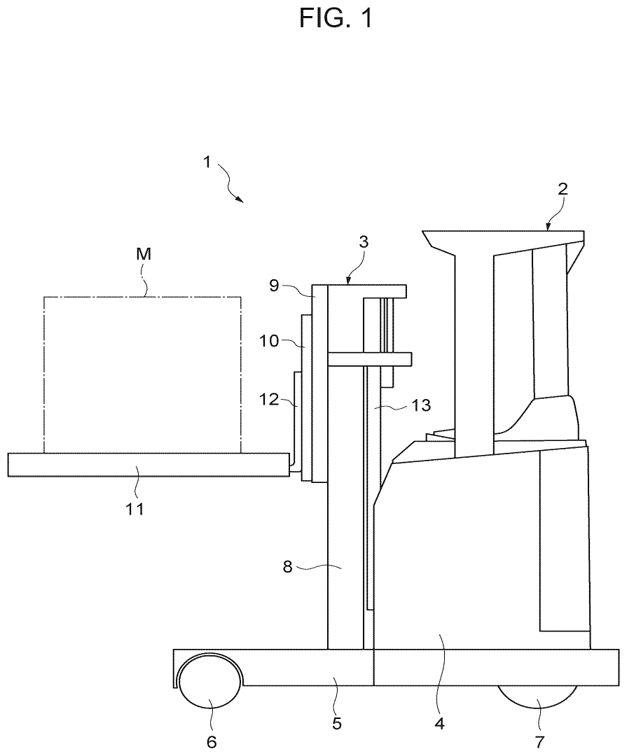

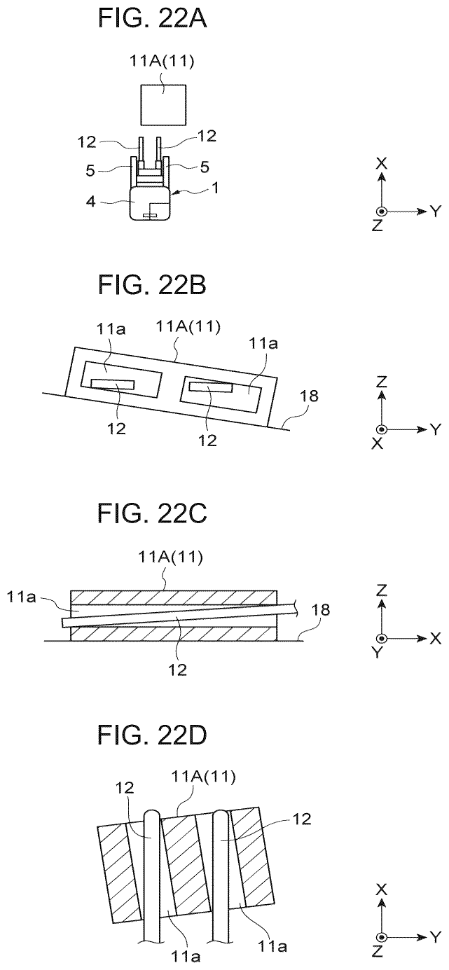

FIG. 1 is a side view illustrating a forklift truck to which a cargo handling control device according to embodiments of the present disclosure is applied. As illustrated in FIG. 1, a forklift truck 1 is a reach type forklift truck. It is noted that a front-rear direction of the forklift truck 1, a left-right direction (lateral direction) of the forklift truck 1, and an up-down direction (height direction) of the forklift truck 1 are defined as an X-axis direction, a Y-axis direction, and a Z-axis direction, respectively (See FIGS. 22A, 22B, 22C and 22D). The forklift truck 1 includes a travelling device 2 and a cargo handling device 3.

The travelling device 2 includes a vehicle body 4, a pair of left and right reach legs 5 extending from the lower part of the vehicle body 4 in a front direction thereof, a left and right front wheels 6 disposed at tips (front ends) of the reach legs 5, and a rear wheel 7, which serves as a drive wheel and a steering wheel, disposed at a rear left of the vehicle body 4. A caster wheel (not illustrated) is disposed at a rear right of the vehicle body 4.

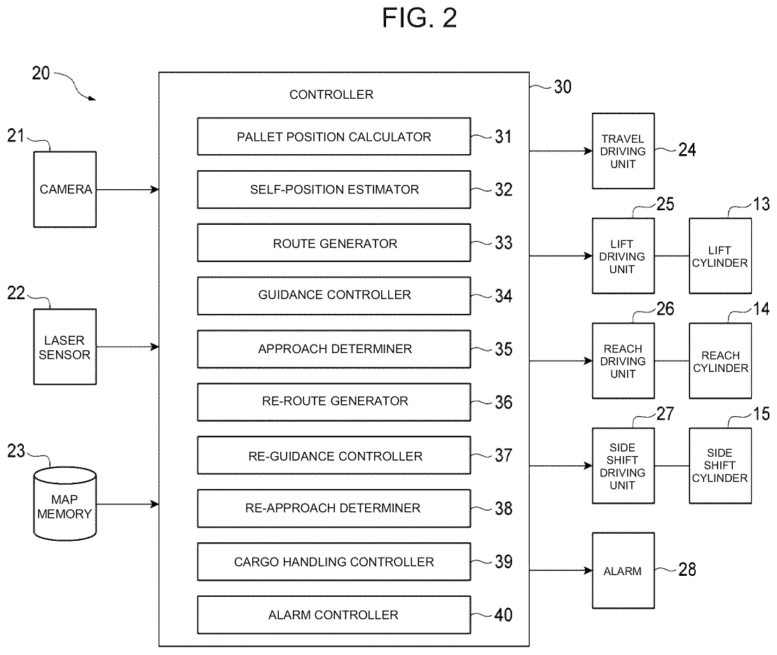

The cargo handling device 3 includes a mast 8 that is positioned between the reach legs 5 and movable in the front-rear direction (X-axis direction) of the vehicle body 4 along the reach legs 5, a pair of left and right forks 12 that is mounted on the mast 8 so as to be movable in the up-down direction (Z-axis direction) via a lift bracket 9 and a load bracket 10 and holds pallets 11, a lift cylinder 13 that moves the forks 12 up and down via the lift bracket 9 and the load bracket 10, a reach cylinder 14 (see FIG. 2) that moves the forks 12 in the front-rear direction (forward and backward) of the vehicle body 4 by moving the mast 8 in the front-rear direction of the vehicle body 4, and a side shift cylinder 15 (see FIG. 2) that moves the forks 12 in the lateral direction (Y-axis direction) via the load bracket 10.

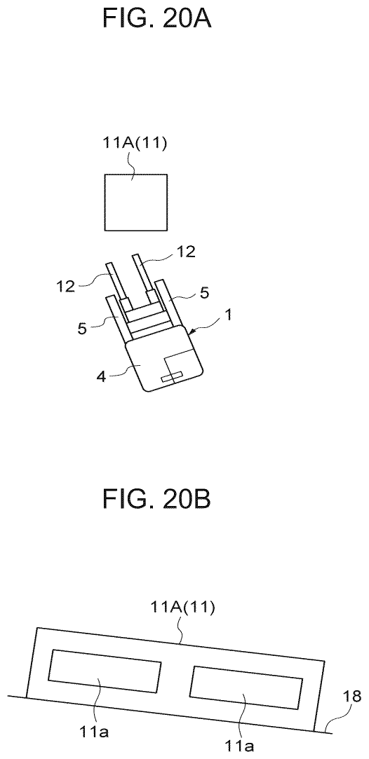

The pallets 11 are plastic or wooden flat pallets, for example. The pallets 11 each has a square or a substantially square shape in plan view. A cargo M is placed on the pallet 11. The pallets 11 each have a pair of fork holes 11a (see FIG. 20B) into which the forks 12 are inserted.

FIG. 2 is a block diagram illustrating a configuration of a cargo handling control device 20 according to a first embodiment of the present disclosure. The cargo handling control device 20 of the present embodiment in FIG. 2 is a device that performs cargo handling with an automated travel of the forklift truck 1.

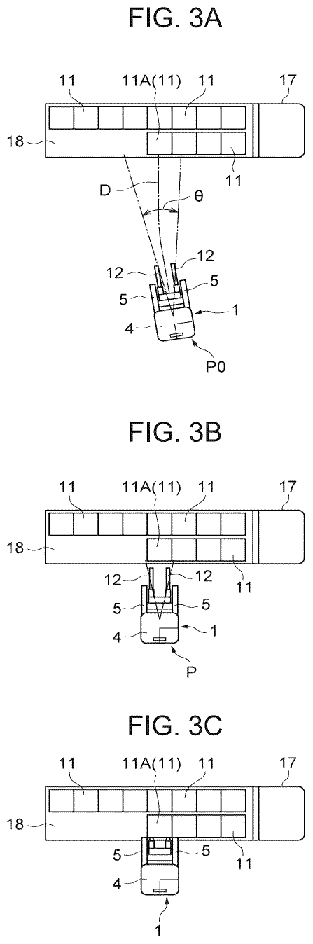

As illustrated in FIGS. 3A, 3B and 3C, the cargo handling control device 20 performs unloading, that is, taking down the pallet 11 mounted on a loading platform 18 of a truck 17. The cargo handling control device 20 performs unloading by causing the forklift truck 1 to move from a start position P0 to the pallet 11 to be unloaded (hereinafter referred to as an unloading target pallet 11A). The unloading target pallet 11A is a cargo handling target. The start position P0 is a position that is on a side of the truck 17 and where the forklift truck 1 starts moving towards the unloading target pallet 11A.

The cargo handling control device 20 includes a camera 21, a laser sensor 22, a map memory 23, a travel driving unit 24, a lift driving unit 25, a reach driving unit 26, a side shift driving unit 27, an alarm 28, and a controller 30. These parts are mounted to the forklift truck 1.

The camera 21 is an image sensor that captures a predetermined angle range (angle of view θ) including an area in front of the forklift truck 1 and outputs image data. The camera 21 captures an image of the pallet 11 loaded on the loading platform 18 of the truck 17. The camera 21 forms to a target detector that detects the unloading target pallet 11A. The camera 21 detects the unloading target pallet 11A with the front of the forklift truck 1 facing the unloading target pallet 11A and outputs the image data corresponding to the detection data.

The laser sensor 22 detects a distance to an object that exists in the vicinity of the forklift truck 1 by irradiating the vicinity of the forklift truck 1 with a laser and receiving laser reflection. The laser sensor 22 outputs the detection data. For example, a LIDAR (light detection and ranging) or a laser range finder is used as the laser sensor 22.

The map memory 23 stores map data of an area where cargo handling is performed by the forklift truck 1. The map data includes buildings, pillars, shelves, and walls. The map data is prepared in advance by the laser sensor 22.

The travel driving unit 24 is configured to drive the forklift truck 1 to travel. The travel driving unit 24 includes a travel motor (not illustrated) that rotates the rear wheel 7 and a steering motor (not illustrated) that steers the rear wheel 7, for example.

The lift driving unit 25 is configured to cause the lift cylinder 13 to extend and contract. The lift driving unit 25 is, for example, an electromagnetic control valve (not illustrated) disposed between a hydraulic pump and the lift cylinder 13.

The reach driving unit 26 is configured to cause the reach cylinder 14 to extend and contract. The reach driving unit 26 is, for example, an electromagnetic control valve (not illustrated) disposed between the hydraulic pump and the reach cylinder 14.

The side shift driving unit 27 is configured to cause the side shift cylinder 15 to extend and contract. The side shift driving unit 27 is, for example, an electromagnetic control valve (not illustrated) disposed between the hydraulic pump and the side shift cylinder 15.

The alarm 28 is a device that provides an alarm when an abnormality occurs during the cargo handling operation. The alarm 28 provides an audio alarm or an alarm display.

The controller 30 includes a central processing unit (CPU), a random access memory (RAM), a read-only memory (ROM), and input/output interfaces. The controller 30 includes a pallet position calculator 31, a self-position estimator 32, a route generator 33, a guidance controller 34, an approach determiner 35, a re-route generator 36, a re-guidance controller 37, a re-approach determiner 38, a cargo handling controller 39, and an alarm controller 40.

The pallet position calculator 31 calculates a position and a state of the unloading target pallet 11A relative to the forklift truck 1 based on the image data by the camera 21. The pallet position calculator 31 calculates the position and the state of the unloading target pallet 11A relative to the forklift truck 1 at the start position P0 and the cargo handling position P. The cargo handling position P is a position corresponding to the unloading target pallet 11A. Specifically, the cargo handling position P is a position in front of the unloading target pallet 11A. The pallet position calculator 31 serves as a position calculator that calculates the position of the unloading target pallet 11A relative to the forklift truck 1.

The self-position estimator 32 estimates the self-position of the forklift truck 1 based on the detection data by the laser sensor 22 and the map data stored in the map memory 23. Specifically, the self-position estimator 32 estimates the self-position of the forklift truck 1 by matching the detection data by the laser sensor 22 with the map data, for example, using simultaneous localization and mapping (SLAM) method. SLAM is a self-position estimation technique that uses sensor data and map data to estimate a self-position.

The route generator 33 generates a travel route D from the start position P0 to the cargo handling position P (see FIG. 3A) based on the position and the state of the unloading target pallet 11A relative to the forklift truck 1 calculated by the pallet position calculator 31 and the self-position of the forklift truck 1 estimated by the self-position estimator 32. The route generator 33 generates the travel route D such that the forklift truck 1 travels forward from the start position P0 to the cargo handling position P.

The guidance controller 34 controls the travel driving unit 24 so that the forklift truck 1 is guided to the cargo handling position P along the travel route D generated by the route generator 33 based on the self-position of the forklift truck 1 estimated by the self-position estimator 32.

The guidance controller 34, the self-position estimator 32 and the route generator 33 cooperate to form an approach controller that controls the forklift truck 1 so that the forklift truck 1 approaches the cargo handling position P corresponding to the position of the unloading target pallet 11A based on the position of the unloading target pallet 11A relative to the forklift truck 1 calculated by the pallet position calculator 31 while the forklift truck 1 is at the start position P0.

The approach determiner 35 determines whether or not an approach of the forklift truck 1 to the cargo handling position P is successful based on the position and the state of the unloading target pallet 11A relative to the forklift truck 1 calculated by the pallet position calculator 31 when the forklift truck 1 reaches the cargo handling position P.

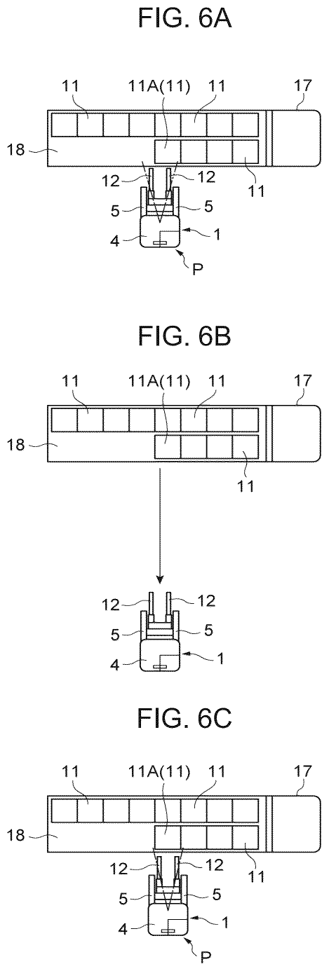

When the approach determiner 35 determines that the approach of the forklift truck 1 to the cargo handling position P is unsuccessful, the re-route generator 36 generates the travel route to the cargo handling position P again based on the position and the state of the unloading target pallet 11A relative to the forklift truck 1 calculated by the pallet position calculator 31 while the forklift truck 1 is at the cargo handling position P and the self-position of the forklift truck 1 estimated by the self-position estimator 32. The re-route generator 36 generates the travel route such that the forklift truck 1 retreats once from the cargo handling position P and then moves forward toward the cargo handling position P (see FIGS. 6A, 6B, and 6C).

The re-guidance controller 37 controls the travel driving unit 24 so that the forklift truck 1 is guided to the cargo handling position P again according to the travel route generated by the re-route generator 36 based on the self-position of the forklift truck 1 estimated by the self-position estimator 32.

The re-guidance controller 37, the self-position estimator 32, and the re-route generator 36 cooperate to form a re-approach controller that controls the forklift truck 1 so that the forklift truck 1 re-approaches the cargo handling position P based on the position of the unloading target pallet 11A relative to the forklift truck 1 calculated by the pallet position calculator 31 when the approach determiner 35 determines that the approach of the forklift truck 1 to the cargo handling position P is unsuccessful.

When the approach determiner 35 determines that the approach of the forklift truck 1 to the cargo handling position P is unsuccessful, the re-approach controller controls the forklift truck 1 so that the forklift truck 1 retreats once from the cargo handling position P and re-approaches the cargo handling position P based on the position of the unloading target pallet 11A relative to the forklift truck 1 calculated by the pallet position calculator 31 while the forklift truck 1 is at the cargo handling position P.

The re-approach determiner 38 determines whether or not the re-approach of the forklift truck 1 to the cargo handling position P is successful based on the position and the state of the unloading target pallet 11A relative to the forklift truck 1 calculated by the pallet position calculator 31 when the forklift truck 1 reaches the cargo handling position P again.

The cargo handling controller 39 controls the lift driving unit 25, the reach driving unit 26, and the side shift driving unit 27 so that unloading of the unloading target pallet 11A is performed when the approach determiner 35 determines that the approach of the forklift truck 1 to the cargo handling position P is successful. In addition, the cargo handling controller 39 controls the lift driving unit 25, the reach driving unit 26, and the side shift driving unit 27 so that the unloading target pallet 11A is unloaded when the re-approach determiner 38 determines that the re-approach of the forklift truck 1 to the cargo handling position P is successful.

The alarm controller 40 outputs an abnormality notification signal to the alarm 28 to provide an alarm when the re-approach determiner 38 determines that the re-approach of the forklift truck 1 to the cargo handling position P is unsuccessful. The alarm controller 40 forms a notification unit that notifies an abnormality when the re-approach determiner 38 determines that the re-approach of the forklift truck 1 to the cargo handling position P is unsuccessful.

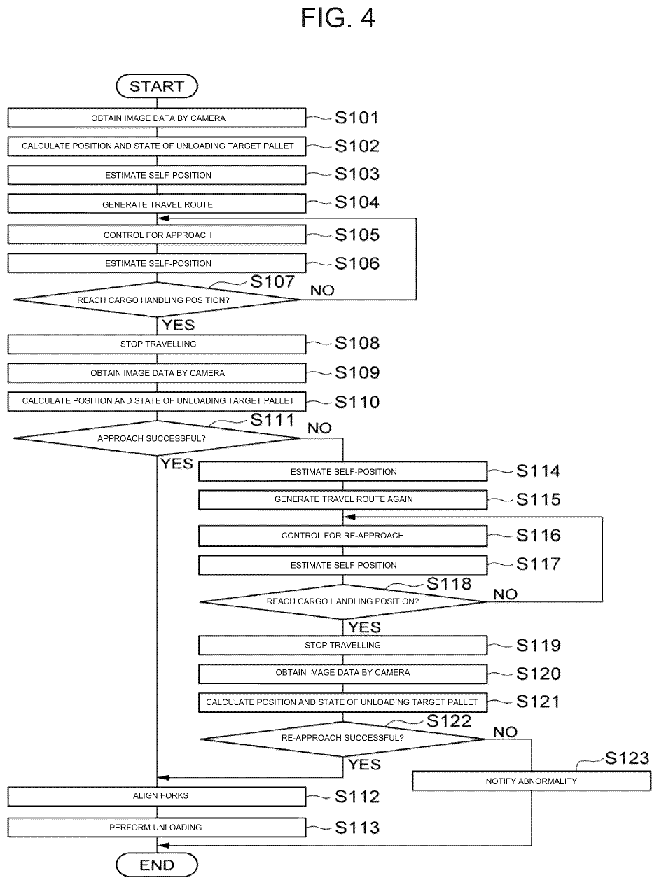

FIG. 4 is a flowchart of unloading control processing performed by the controller 30. This processing is executed when the forklift truck 1 reaches the start position P0, as illustrated in FIG. 3A. When the forklift truck 1 reaches the start position P0, the front of the forklift truck 1 faces forward to the unloading target pallet 11A, and the camera 21 can recognize the unloading target pallet 11A.

In FIG. 4, firstly, the controller 30 obtains the image data by the camera 21 (step S101). Then, the controller 30 calculates the position and the state of the unloading target pallet 11A relative to the forklift truck 1 based on the image data by the camera 21 (step S102).

Subsequently, the controller 30 estimates the self-position of the forklift truck 1 based on the detection data by the laser sensor 22 and the map data stored in the map memory 23 (step S103). Next, the controller 30 generates a travel route D from the start position P0, which is the current position of the forklift truck 1, to the cargo handling position P, as illustrated in FIG. 3A (step S104). Then, the controller 30 controls the travel driving unit 24 so that the forklift truck 1 approaches the cargo handling position P in accordance with the travel route D (step S105).

Subsequently, the controller 30 estimates the self-position of the forklift truck 1 based on the detection data by the laser sensor 22 and the map data (step S106). Then, the controller 30 determines whether or not the forklift truck 1 has reached the cargo handling position P based on the self-position of the forklift truck 1 (step S107). When the controller 30 determines that the forklift truck 1 has not reached the cargo handling position P, the controller 30 executes step S105 again.

When the controller 30 determines that the forklift truck 1 has reached the cargo handling position P, as illustrated in FIG. 3B, the controller 30 controls the travel driving unit 24 so that the forklift truck 1 stops travelling (step S108). Subsequently, the controller 30 obtains the image data by the camera 21 (step S109). Then, the controller 30 calculates the position and the state of the unloading target pallet 11A relative to the forklift truck 1 based on the image data by the camera 21 (step S110).

Subsequently, the controller 30 determines whether or not the approach of the forklift truck 1 to the cargo handling position P is successful based on the position and the state of the unloading target pallet 11A relative to the forklift truck 1 (step S111).

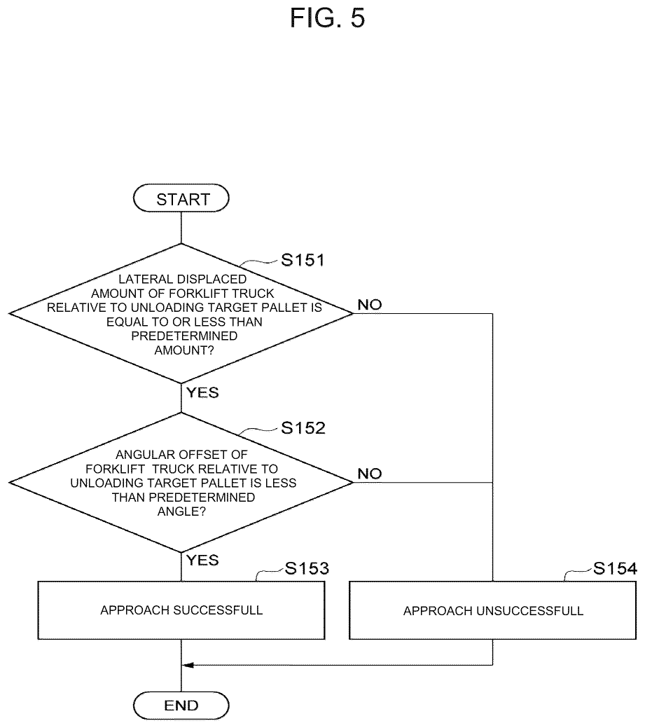

FIG. 5 is a flowchart showing details of step S111. In FIG. 5, the controller 30 determines whether or not a lateral displaced amount of the forklift truck 1 relative to the unloading target pallet 11A is equal to or less than a predetermined amount based on the position of the unloading target pallet 11A relative to the forklift truck 1 (step S151).

The lateral displaced amount of the forklift truck 1 is an amount of displacement of the forklift truck 1 in the lateral direction (left-right direction). The predetermined amount is set to a value that allows the forks 12 to be inserted into the fork holes 11a of the unloading target pallet 11A by moving the forks 12 in the lateral direction with the side shift cylinder 15. The predetermined amount is, for example, the maximum lateral movement amount of the forks 12 from the center position of the forklift truck 1 in the left-right direction.

When the controller 30 determines that the lateral displaced amount of the forklift truck 1 relative to the unloading target pallet 11A is equal to or less than the predetermined amount, the controller 30 determines whether or not an angular offset of the forklift truck 1 relative to the unloading target pallet 11A is equal to or less than a predetermined angle based on the state of the unloading target pallet 11A (step S152).

The angular offset of the forklift truck 1 is an offset amount of the yaw angle of the forklift truck 1. The predetermined angle is set to an angle that allows the forks 12 to be inserted into the fork holes 11a of the unloading target pallet 11A by moving the forks 12 in the lateral direction with the side shift cylinder 15.

The controller 30 determines that the approach of the forklift truck 1 to the cargo handling position P is successful when the angular offset of the forklift truck 1 relative to the unloading target pallet 11A is equal to or less than the predetermined angle (step S153).

When the controller 30 determines in step S151 that the lateral displaced amount of the forklift truck 1 relative to the unloading target pallet 11A is not equal to or less than the predetermined amount, or the controller 30 determines in step S152 that the angular offset of the forklift truck 1 relative to the unloading target pallet 11A is not equal to or less than the predetermined angle, the controller 30 determines that the approach of the forklift truck 1 to the cargo handling position P is unsuccessful (step S154).

Returning to FIG. 4, when the controller 30 determines in step S111 that the approach of the forklift truck 1 to the cargo handling position P is successful, the controller 30 controls the lift driving unit 25 and the side shift driving unit 27 so that the forks 12 are aligned to the fork holes 11a of the unloading target pallet 11A (step S112). Then, as illustrated in FIG. 3C, the controller 30 controls the reach driving unit 26 and the lift driving unit 25 so that the forks 12 are inserted into the fork holes 11a of the unloading target pallet 11A, and unloading of the unloading target pallet 11A is performed (step S113).

When the controller 30 determines in step S111 that the approach of the forklift truck 1 to the cargo handling position P is unsuccessful, the controller 30 estimates the self-position of the forklift truck 1 based on the detection data by the laser sensor 22 and the map data stored in the map memory 23 (step S114).

Subsequently, as illustrated in FIGS. 6A, 6B, and 6C, the controller 30 generates a travel route from the current position of the forklift truck 1 to the cargo handling position P again (step S115). At this time, the controller 30 generates the travel route such that the forklift truck 1 retreats from the current position by a predetermined amount and travels forward. Then, the controller 30 controls the travel driving unit 24 so that the forklift truck 1 re-approaches the cargo handling position P in accordance with the travel route (step S116).

Subsequently, the controller 30 estimates the self-position of the forklift truck 1 based on the detection data by the laser sensor 22 and the map data (step S117). Then, the controller 30 determines whether or not the forklift truck 1 has reached the cargo handling position P based on the self-position of the forklift truck 1 (step S118). When the controller 30 determines that the forklift truck 1 has not reached the cargo handling position P, the controller 30 executes step S116 again.

When the controller 30 determines that the forklift truck 1 has reached the cargo handling position P, the controller 30 controls the travel driving unit 24 so that the forklift truck 1 stops travelling (step S119). Subsequently, the controller 30 obtains the image data by the camera 21 (step S120). Then, the controller 30 calculates the position and the state of the unloading target pallet 11A relative to the forklift truck 1 based on the image data by the camera 21 (step S121).

Subsequently, the controller 30 determines whether or not the re-approach of the forklift truck 1 to the cargo handling position P is successful based on the position and the state of the unloading target pallet 11A relative to the forklift truck 1 (step S122). The details of the step S122 are the same as those of step S111 described above.

When the controller 30 determines that the re-approach of the forklift truck 1 to the cargo handling position P is successful, the controller 30 executes step S112 described above. When the controller 30 determines that the re-approach of the forklift truck 1 to the cargo handling position P is unsuccessful, the controller 30 outputs an abnormality notification signal to the alarm 28 (step S123).

Here, the pallet position calculator 31 executes steps S101, S102, S109, S110, S120, and S121. The self-position estimator 32 executes steps S103, S106, S114, and S117. The route generator 33 executes step S104. The guidance controller 34 executes steps S105, S107, and S108. The approach determiner 35 executes step S111. The re-route generator 36 executes step S115. The re-guidance controller 37 executes steps S116, S118, and S119. The re-approach determiner 38 executes step S122. The cargo handling controller 39 executes steps S112 and S113. The alarm controller 40 executes step S123.

In the cargo handling control device 20 having the above-described configuration, the forklift truck 1, which performs unloading, travels toward the truck 17 on which the pallet 11 is loaded on the loading platform 18 as illustrated in FIG. 3A, and stops at the start position P0 that is spaced from the side of the truck 17 by a certain distance in a state where the front of the forklift truck 1 faces the unloading target pallet 11A.

In this state, the camera 21 captures an image of the unloading target pallet 11A. Subsequently, based on the image data by the camera 21, the position and the state of the unloading target pallet 11A relative to the forklift truck 1 are calculated, and the travel route D to the cargo handling position P in front of the unloading target pallet 11A is generated. Then, the forklift truck 1 approaches the cargo handling position P along the travel route D.

As illustrated in FIG. 3B, when the forklift truck 1 reaches the cargo handling position P, an image of the unloading target pallet 11A is captured by the camera 21. Then, based on the image data by the camera 21, the position and the state of the unloading target pallet 11A relative to the forklift truck 1 are calculated, and whether or not the approach of the forklift truck 1 to the cargo handling position P is successful is determined based on the calculation result.

When the approach of the forklift truck 1 to the cargo handling position P is successful, the unloading of the unloading target pallet 11A is performed as illustrated in FIG. 3C. Specifically, the unloading target pallet 11A is held by the forks 12 by inserting the forks 12 of the forklift truck 1 into the fork holes 11a of the unloading target pallet 11A and raising the forks 12 in that state. Then, the forklift truck 1 transports the unloading target pallet 11A to a designated place.

On the other hand, as illustrated in FIG. 6A, when the approach of the forklift truck 1 to the cargo handling position P is unsuccessful due to the dislocation of the forklift truck 1 relative to the unloading target pallet 11A, a new travel route to the cargo handling position P is generated again. Then, the forklift truck 1 re-approaches the cargo handling position P along the new travel route as illustrated in FIGS. 6B and 6C.

When the re-approach of the forklift truck 1 to the cargo handling position P is successful, unloading of the unloading target pallet 11A is performed. When the re-approach of the forklift truck 1 to the cargo handling position P is also unsuccessful, the alarm 28 outputs an alarm.

As described above, in the present embodiment, the unloading target pallet 11A is detected by the camera 21 at the start position P0 firstly, and the position of the unloading target pallet 11A relative to the forklift truck 1 is calculated. Then, based on the position of the unloading target pallet 11A relative to the forklift truck 1, the forklift 1 is controlled so that the forklift truck 1 approaches the cargo handling position P corresponding to the position of the unloading target pallet 11A. When the forklift truck 1 reaches the cargo handling position P, the unloading target pallet 11A is detected by the camera 21 and the position of the unloading target pallet 11A relative to the forklift truck 1 is calculated. Then, based on the position of the unloading target pallet 11A relative to the forklift truck 1, whether or not the approach of the forklift truck 1 to the cargo handling position P is successful is determined. When it is determined that the approach of the forklift truck 1 to the cargo handling position P is unsuccessful, the forklift truck 1 is controlled so that the forklift truck 1 re-approaches the cargo handling position P based on the position of the unloading target pallet 11A relative to the forklift truck 1. In this way, if the re-approach of the forklift truck 1 to the cargo handling position P is unsuccessful, by retrying the approach of the forklift truck 1 to the cargo handling position P, the probability of the forklift 1 reaching the appropriate cargo handling position P corresponding to the position of the unloading target pallet 11A increases. As a result, the success rate of unloading by forklift truck 1 is increased.

In the present embodiment, unloading of the unloading target pallet 11A is performed when it is determined that the approach of the forklift truck 1 to the cargo handling position P is successful. Therefore, a distance traveled by the forklift truck 1 increases only when the approach of the forklift truck 1 to the cargo handling position P is unsuccessful. As a result, the travelling time of the forklift truck 1 can be suppressed.

In the present embodiment, when the approach of the forklift truck 1 to the cargo handling position P is unsuccessful, the unloading target pallet 11A is detected by the camera 21 at the cargo handling position P and the position of the unloading target pallet 11A relative to the forklift truck 1 is calculated. Then, based on the position of the unloading target pallet 11A relative to the forklift truck 1, the forklift 1 is controlled so that the forklift truck 1 once retreats from the cargo handling position P and re-approaches the cargo handling position P. Accordingly, the approach of the forklift truck 1 to the cargo handling position P is retried while an accuracy in positioning the unloading target pallet 11A relative to the forklift truck 1 is secured. As a result, the probability of the forklift truck 1 reaching the appropriate cargo handling position P corresponding to the position of the unloading target pallet 11A is further increased.

In addition, in the present embodiment, when the lateral displaced amount of the forklift truck 1 relative to the unloading target pallet 11A is equal to or less than the predetermined amount, it is determined that the approach of the forklift truck 1 to the cargo handling position P is successful, since it is possible to adjust the positions of the forks 12 relative to the unloading target pallet 11A to appropriate positions by moving the forks 12 in the left-right direction with the side shift cylinder 15. Since a retry of the approach of the forklift truck 1 to the cargo handling position P is not required, the processing of the controller 30 may be simplified.

In addition, in the present embodiment, when the re-approach of the forklift truck 1 to the cargo handling position P is unsuccessful, an abnormality is notified. As a result, it is possible to inform that unloading will be stopped because the approach of the forklift truck 1 to the cargo handling position P is unsuccessful twice consecutively.

Furthermore, in the present embodiment, the camera 21 detects the unloading target pallet 11A in a state where the front of the forklift truck 1 faces the unloading target pallet 11A when the forklift 1 is in either the start position P0 or the cargo handling position P. Since the number of cameras 21 to be used is minimized, the cost can be reduced.

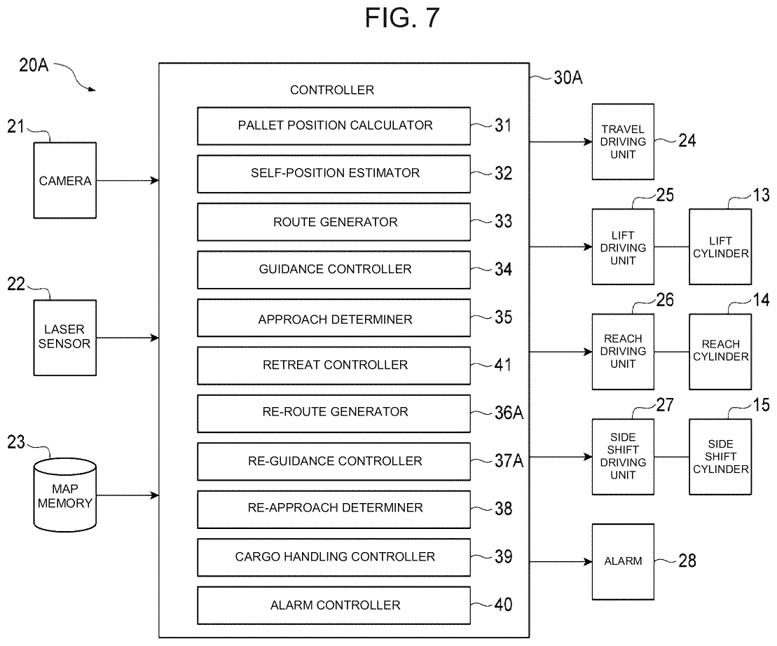

FIG. 7 is a block diagram illustrating a configuration of a cargo handling control device 20A according to a second embodiment of the present disclosure. As illustrated in FIG. 7, the cargo handling control device 20A includes a controller 30A in place of the controller 30 of the first embodiment.

The controller 30A includes the pallet position calculator 31, the self-position estimator 32, the route generator 33, the guidance controller 34, the approach determiner 35, a retreat controller 41, a re-route generator 36A, a re-guidance controller 37A, the re-approach determiner 38, the cargo handling controller 39, and the alarm controller 40.

The retreat controller 41 controls the travel driving unit 24 so that the forklift truck 1 retreats once from the cargo handling position P when the approach determiner 35 determines that the approach of the forklift truck 1 to the cargo handling position P is unsuccessful. The retreat controller 41 controls the travel driving unit 24 so that the forklift truck 1 retreats once from the cargo handling position P to the start position P0.

The re-route generator 36A generates the travel route to the cargo handling position P again based on the position and the state of the unloading target pallet 11A relative to the forklift truck 1 calculated by the pallet position calculator 31 and the self-position of the forklift truck 1 estimated by the self-position estimator 32 at the start position P0 when the approach determiner 35 determines that the approach of the forklift truck 1 to the cargo handling position P is unsuccessful. The re-route generator 36A generates the travel route such that the forklift truck 1 travels forward toward the cargo handling position P in the same manner as the route generator 33 does.

The re-guidance controller 37A controls the travel driving unit 24 so that the forklift truck 1 is guided to the cargo handling position P again in accordance with the travel route generated by the re-route generator 36A based on the self-position of the forklift truck 1 estimated by the self-position estimator 32.

The re-guidance controller 37A, the self-position estimator 32, the retreat controller 41, and the re-route generator 36A cooperate to form a re-approach controller that controls the forklift truck 1 so that the forklift truck 1 re-approaches the cargo handling position P based on the position of the unloading target pallet 11A relative to the forklift truck 1 calculated by the pallet position calculator 31 when the approach determiner 35 determines that the approach of the forklift truck 1 to the cargo handling position P is unsuccessful.

When it is determined that the approach of the forklift truck 1 to the cargo handling position P is unsuccessful, the re-approach controller controls the forklift truck 1 so that the forklift truck 1 retreats once from the cargo handling position P to the start position P0, and then controls the forklift truck 1 so that the forklift truck 1 re-approaches the cargo handling position P based on the position of the unloading target pallet 11A relative to the forklift truck 1 calculated by the pallet position calculator 31 while the forklift truck 1 is at the start position P0.

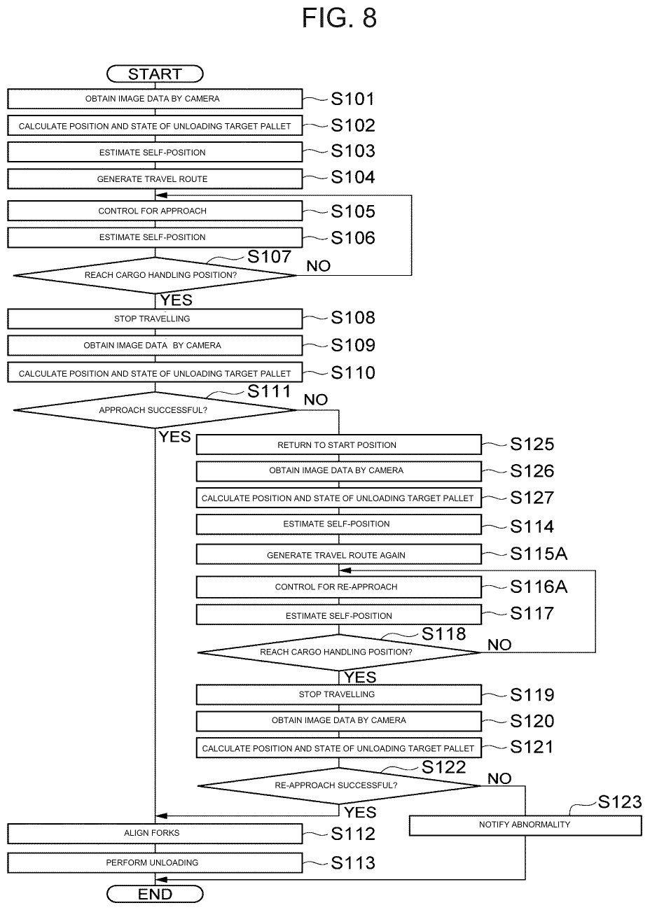

FIG. 8 is a flowchart of unloading control processing performed by the controller 30A and corresponds to FIG. 4. In FIG. 8, the controller 30A executes steps S101 to S111 in the same manner as the above-described first embodiment.

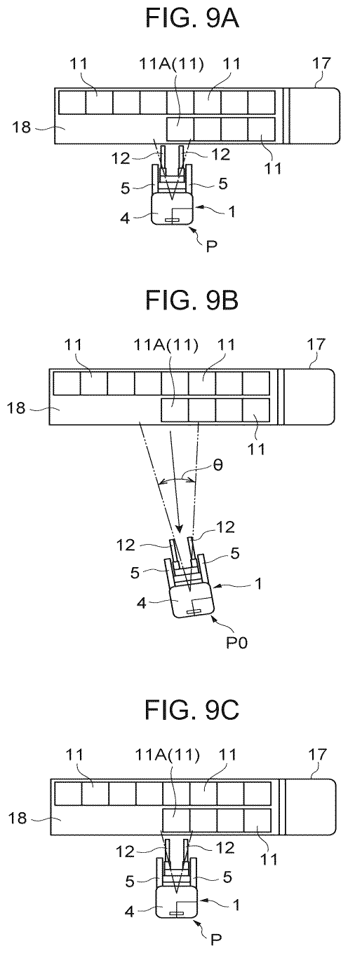

When the controller 30A determines in step S111 that the approach of the forklift truck 1 to the cargo handling position P is unsuccessful, the controller 30A controls the travel driving unit 24 so that the forklift truck 1 returns to the start position P0, as illustrated in FIGS. 9A and 9B (step S125).

Subsequently, the controller 30A obtains the image data by the camera 21 (step S126). Then, the controller 30A calculates the position and the state of the unloading target pallet 11A relative to the forklift truck 1 based on the image data by the camera 21 (step S127). Next, the controller 30A executes step S114 in the same manner as the above-described first embodiment.

Next, the controller 30A generates a travel route from the start position P0, corresponding to the current position of the forklift truck 1, to the cargo handling position P again (step S115A). Subsequently, the controller 30A controls the travel driving unit 24 so that the forklift truck 1 re-approaches the cargo handling position P in accordance with the travel route (step S116A). Then, the controller 30A executes step S117 and the subsequent steps in the same manner as the above-described first embodiment.

Here, the pallet position calculator 31 executes steps S101, S102, S109, S110, S126, S127, S120, and S121. The self-position estimator 32 executes steps S103, S106, S114, and S117. The route generator 33 executes step S104. The guidance controller 34 executes steps S105, S107, and S108. The approach determiner 35 executes step S111. The retreat controller 41 executes step S125. The re-route generator 36A executes step S115A. The re-guidance controller 37A executes steps S116A, S118, and S119. The re-approach determiner 38 executes step S122. The cargo handling controller 39 executes steps S112 and S113. The alarm controller 40 executes step S123.

In the cargo handling control device 20A having this configuration, when the forklift truck 1 reaches the cargo handling position P, as illustrated in FIG. 9A, the camera 21 captures an image of the unloading target pallet 11A and whether or not the approach of the forklift truck 1 to the cargo handling position P is successful is determined, in the same manner as the first embodiment.

When the approach of the forklift truck 1 to the cargo handling position P is unsuccessful due to the dislocation of the forklift truck 1 relative to the unloading target pallet 11A, the forklift truck 1 returns to the start position P0, as illustrated in FIG. 9B.

Then, at the start position P0, the image of the unloading target pallet 11A is captured by the camera 21, the position and the state of the unloading target pallet 11A relative to the forklift truck 1 are calculated, and the travel route to the cargo handling position P is generated again. Then, the forklift truck 1 re-approaches the cargo handling position P along the travel route as illustrated in FIG. 9C. The subsequent operations are the same as those of the above-described first embodiment.

As has been described, in the second embodiment, when the approach of the forklift truck 1 to the cargo handling position P is unsuccessful, the forklift truck 1 is firstly controlled so that the forklift truck 1 retreats once from the cargo handling position P. Then, based on the position and the state of the unloading target pallet 11A relative to the forklift truck 1, the forklift truck 1 is controlled so that the forklift truck 1 re-approaches the cargo handling position P. Therefore, a travel distance for the forklift truck 1 to retry the approach of the forklift truck 1 to the cargo handling position P after the travel route is set may be shortened. As a result, the probability of the forklift truck 1 reaching the appropriate cargo handling position P corresponding to the position of the unloading target pallet 11A is further increased.

In the present embodiment, when the approach of the forklift truck 1 to the cargo handling position P is unsuccessful, the forklift truck 1 retreats once to the start position P0 that is a known position as position information in advance, which can simplify processing by the controller 30A.

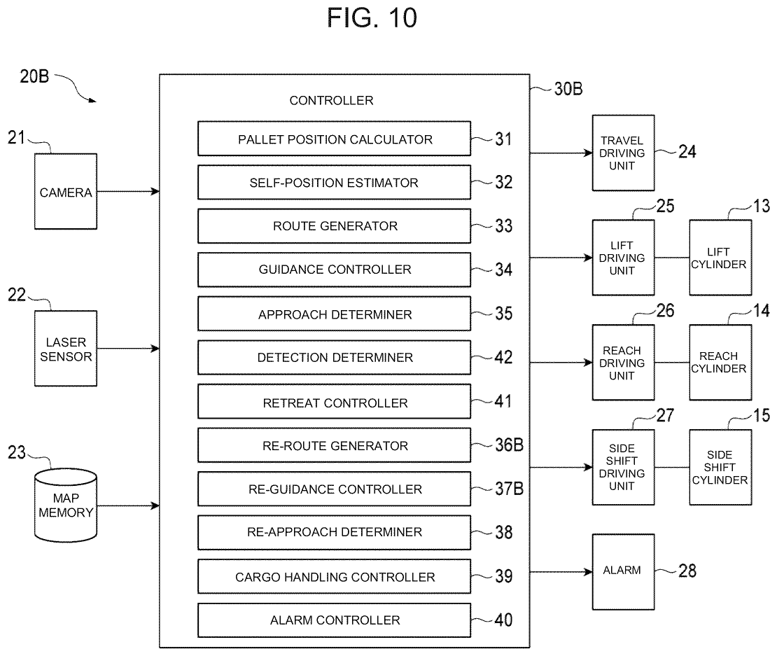

FIG. 10 is a block diagram illustrating a configuration of a cargo handling control device 20B according to a third embodiment of the present disclosure. As illustrated in FIG. 10, the cargo handling control device 20B of the present embodiment includes a controller 30B in place of the controller 30 of the first embodiment.

The controller 30B includes the pallet position calculator 31, the self-position estimator 32, the route generator 33, the guidance controller 34, the approach determiner 35, a detection determiner 42, the retreat controller 41, a re-route generator 36B, a re-guidance controller 37B, the re-approach determiner 38, the cargo handling controller 39, and the alarm controller 40.

The detection determiner 42 determines whether or not the unloading target pallet 11A is detectable by the camera 21 at the cargo handling position P when the approach determiner 35 determines that the approach of the forklift truck 1 to the cargo handling position P is unsuccessful.

The retreat controller 41 controls the travel driving unit 24 so that the forklift truck 1 retreats once from the cargo handling position P when the detection determiner 42 determines that the unloading target pallet 11A is not detectable by the camera 21 at the cargo handling position P. The retreat controller 41 controls the travel driving unit 24 so that the forklift truck 1 retreats once from the cargo handling position P to the start position P0.

The re-route generator 36B generates a travel route to the cargo handling position P again, when the detection determiner 42 determines that the unloading target pallet 11A is detectable by the camera 21 at the cargo handling position P, based on the position and the state of the unloading target pallet 11A relative to the forklift truck 1 calculated by the pallet position calculator 31 and the self-position of the forklift truck 1 estimated by the self-position estimator 32 at the cargo handling position P. At this time, the re-route generator 36B generates the travel route such that the forklift truck 1 retreats once from the cargo handling position P and then travels forward toward the cargo handling position P (see FIGS. 6A, 6B, and 6C).

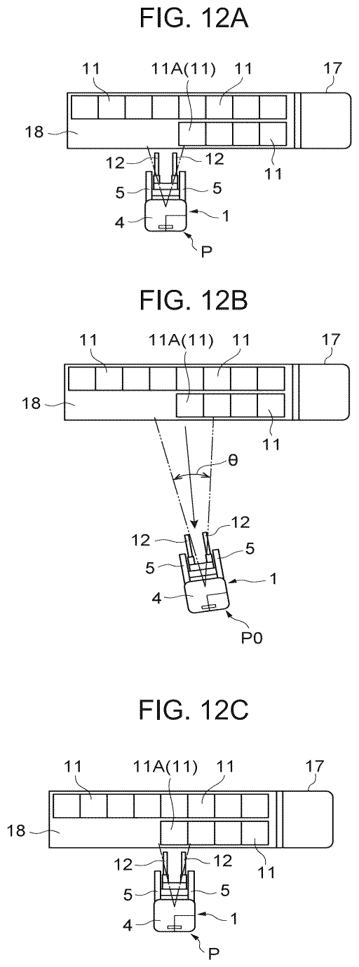

When the detection determiner 42 determines that the unloading target pallet 11A is not detectable by the camera 21 at the cargo handling position P, the re-route generator 36B generates the travel route to the cargo handling position P again based on the position and the state of the unloading target pallet 11A relative to the forklift truck 1 calculated by the pallet position calculator 31 and the self-position of the forklift truck 1 estimated by the self-position estimator 32 at the start position P0. At this time, the re-route generator 36B generates the travel route such that the forklift truck 1 travels forward toward the cargo handling position P (see FIGS. 12A, 12B, 12C).

The re-guidance controller 37B controls the travel driving unit 24 so that the forklift truck 1 is guided to the cargo handling position P again in accordance with the travel route generated by the re-route generator 36B based on the self-position of the forklift truck 1 estimated by the self-position estimator 32.

The re-guidance controller 37B, the self-position estimator 32, the retreat controller 41, and the re-route generator 36B cooperate to form a re-approach controller that controls the forklift truck 1 so that the forklift truck 1 re-approaches the cargo handling position P based on the position of the unloading target pallet 11A relative to the forklift truck 1 calculated by the pallet position calculator 31 when the approach determiner 35 determines that the approach of the forklift truck 1 to the cargo handling position P is unsuccessful.

The re-approach controller controls the forklift truck 1, when the detection determiner 42 determines that the unloading target pallet 11A is detectable by the camera 21 at the cargo handling position P, so that the forklift truck 1 retreats once from the cargo handling position P and re-approaches the cargo handling position P based on the position of the unloading target pallet 11A relative to the forklift truck 1 calculated by the pallet position calculator 31 while the forklift truck 1 is at the cargo handling position P.

The re-approach controller controls the forklift truck 1, when the detection determiner 42 determines that the unloading target pallet 11A is not detectable by the camera 21 at the cargo handling position P, so that the forklift truck 1 retreats once from the cargo handling position P to the start position P0 and re-approaches the cargo handling position P based on the position of the unloading target pallet 11A relative to the forklift truck 1 calculated by the pallet position calculator 31.

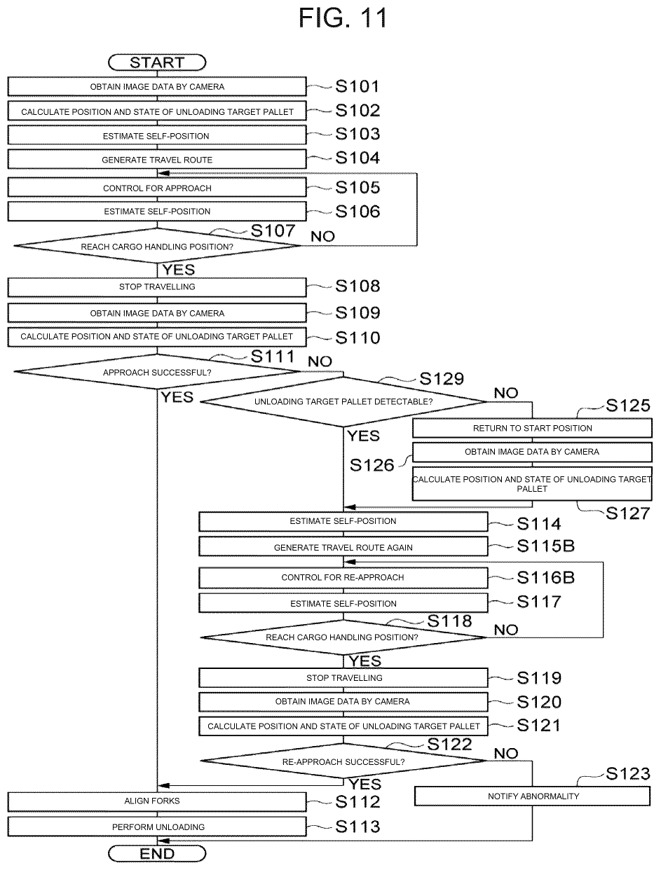

FIG. 11 is a flowchart of unloading control processing performed by the controller 30B and corresponds to FIGS. 4 and 8. In FIG. 11, the controller 30B executes steps S101 to S111 in the same manner as the above-described first and second embodiments.

When the controller 30B determines in step S111 that the approach of the forklift truck 1 to the cargo handling position P is unsuccessful, the controller 30B determines whether or not the unloading target pallet 11A is detectable by the camera 21 at the cargo handling position P based on the position and the state of the unloading target pallet 11A relative to the forklift truck 1 calculated in step S110 (step S129).

At this time, when the unloading target pallet 11A is within the angle of view θ of the camera 21 (see FIG. 9A), the camera 21 can detect the unloading target pallet 11A. When the unloading target pallet 11A is outside the angle of view θ of the camera 21 (see FIG. 12A), the camera 21 cannot detects the unloading target pallet 11A.

When the controller 30B determines that the unloading target pallet 11A is detectable by the camera 21 at the cargo handling position P, the controller 30B executes step S114 in the same manner as the above-described first embodiment.

When the controller 30B determines that the unloading target pallet 11A is not detectable by the camera 21 at the cargo handling position P, the controller 30B executes steps S125 to S127, and S114 in the same manner as the above-described second embodiment.

After the step S114 is performed, the controller 30B generates a travel route from the current position of the forklift truck 1 to the cargo handling position P again (step S115B). Subsequently, the controller 30B controls the travel driving unit 24 so that the forklift truck 1 re-approaches the cargo handling position P in accordance with the travel route (step S116B). Then, the controller 30B executes step S117 and the subsequent steps in the same manner as the above-described first and second embodiments.

Here, the pallet position calculator 31 executes steps S101, S102, S109, S110, S126, S127, S120, and S121. The self-position estimator 32 executes steps S103, S106, S114, and S117. The route generator 33 executes step S104. The guidance controller 34 executes steps S105, S107, and S108. The approach determiner 35 executes step S111. The detection determiner 42 executes step S129. The retreat controller 41 executes step S125. The re-route generator 36B executes step S115B. The re-guidance controller 37B executes steps S116B, S118, and S119. The re-approach determiner 38 executes step S122. The cargo handling controller 39 executes steps S112 and S113. The alarm controller 40 executes step S123.

In the cargo handling control device 20B having the above-described configuration, when the forklift truck 1 reaches the cargo handling position P, as illustrated in FIG. 12A, whether or not the approach of the forklift truck 1 to the cargo handling position P is successful is determined. Then, when the approach of the forklift truck 1 to the cargo handling position P is unsuccessful, whether or not the unloading target pallet 11A is detectable by the camera 21 is determined.

When the unloading target pallet 11A is detectable by the camera 21, the travel route to the cargo handling position P is generated again based on the position and the state of the unloading target pallet 11A relative to the forklift truck 1 at the cargo handling position P, in the same manner as the above-described first embodiment. Then, the forklift truck 1 re-approaches the cargo handling position P along the travel route D.

When the camera 21 cannot detect the unloading target pallet 11A, the forklift truck 1 returns to the start position P0, as illustrated in FIG. 12B, in the same manner as the above-described second embodiment.

Then, at the start position P0, the image of the unloading target pallet 11A is captured by the camera 21, the position and the state of the unloading target pallet 11A relative to the forklift truck 1 are detected, and the travel route to the cargo handling position P is generated again. Then, the forklift truck 1 re-approaches the cargo handling position P along the travel route as illustrated in FIG. 12C. The subsequent operations are the same as those of the above-described second embodiment.

As has been described, in the present embodiment, when the camera 21 can detect the unloading target pallet 11A at the cargo handling position P, the forklift truck 1 is controlled so that the forklift truck 1 retreats once from the cargo handling position P and re-approaches the cargo handling position P based on the position of the unloading target pallet 11A relative to the forklift truck 1 at the cargo handling position P. When the camera 21 cannot detect the unloading target pallet 11A at the cargo handling position P, after the forklift truck 1 is controlled so that the forklift truck 1 retreats once from the cargo handling position P, the forklift truck 1 is controlled to re-approach the cargo handling position P based on the position of the unloading target pallet 11A relative to the forklift truck 1. In this way, by changing a method of a retry of approach of the forklift truck 1 to the cargo handling position P depending on whether or not the camera 21 can detect the unloading target pallet 11A at the cargo handling position P, a retry of the approach of the forklift truck 1 to the cargo handling position P may be performed appropriately according to the use environment.

In addition, in the present embodiment, when it is determined that the unloading target pallet 11A is not detectable by the camera 21, the forklift truck 1 retreats once to the start position P0 that is known position as position information, so that processing by the controller 30B can be simplified.

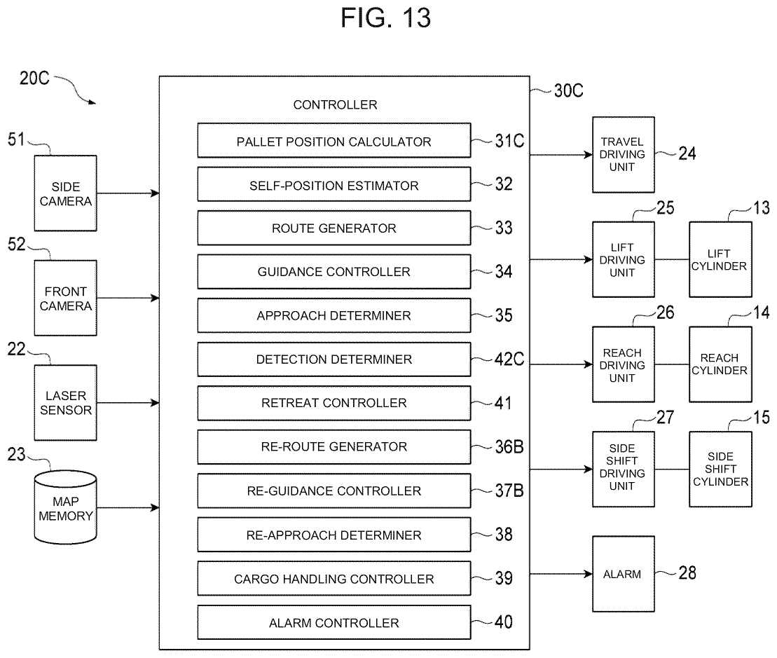

FIG. 13 is a block diagram illustrating a configuration of a cargo handling control device 20C according to a fourth embodiment of the present disclosure. As illustrated in FIG. 13, the cargo handling control device 20C of the present embodiment includes side cameras 51 and a front camera 52 in place of the camera 21 in the third embodiment.

The side cameras 51 and the front camera 52 are image sensors that capture an image of the pallet 11 loaded on the loading platform 18 of the truck 17. The side cameras 51 and the front camera 52 cooperate to form a target detector that detects the unloading target pallet 11A.

The side cameras 51 each captures an image of a predetermined angular range including the side of the forklift truck 1, and outputs image data. The side cameras 51 are disposed on the left and right sides of the forklift truck 1. The side cameras 51 are a first detector that detects the unloading target pallet 11A with the side of the forklift truck 1 facing the unloading target pallet 11A.

The front camera 52 captures an image of a predetermined angular range including the front of the forklift truck 1, and outputs image data in the same manner as the above-described camera 21. The front camera 52 is a second detector that detects the unloading target pallet 11A with the front of the forklift truck 1 facing the unloading target pallet 11A.

The cargo handling control device 20C includes a controller 30C in place of the controller 30B of the third embodiment. The controller 30C includes a pallet position calculator 31C, the self-position estimator 32, the route generator 33, the guidance controller 34, the approach determiner 35, a detection determiner 42C, the retreat controller 41, the re-route generator 36B, the re-guidance controller 37B, the re-approach determiner 38, the cargo handling controller 39, and the alarm controller 40.

The pallet position calculator 31C calculates the position and the state of the unloading target pallet 11A relative to the forklift truck 1 at the start position P0 based on the image data by the side cameras 51. The pallet position calculator 31C calculates the position and the state of the unloading target pallet 11A relative to the forklift truck 1 at the cargo handling position P based on the image data by the front camera 52.

The pallet position calculator 31C forms a position detector that calculates the position of the unloading target pallet 11A relative to the forklift truck 1 based on the detection data by the side cameras 51 while the forklift truck 1 is at the start position P0, and calculates the position of the unloading target pallet 11A relative to the forklift truck 1 based on the detection data by the front camera 52 while the forklift truck 1 is at the cargo handling position P.

The detection determiner 42C determines whether or not the front camera 52 can detect the unloading target pallet 11A at the cargo handling position P when the approach determiner 35 determines that the approach of the forklift truck 1 to the cargo handling position P is unsuccessful.

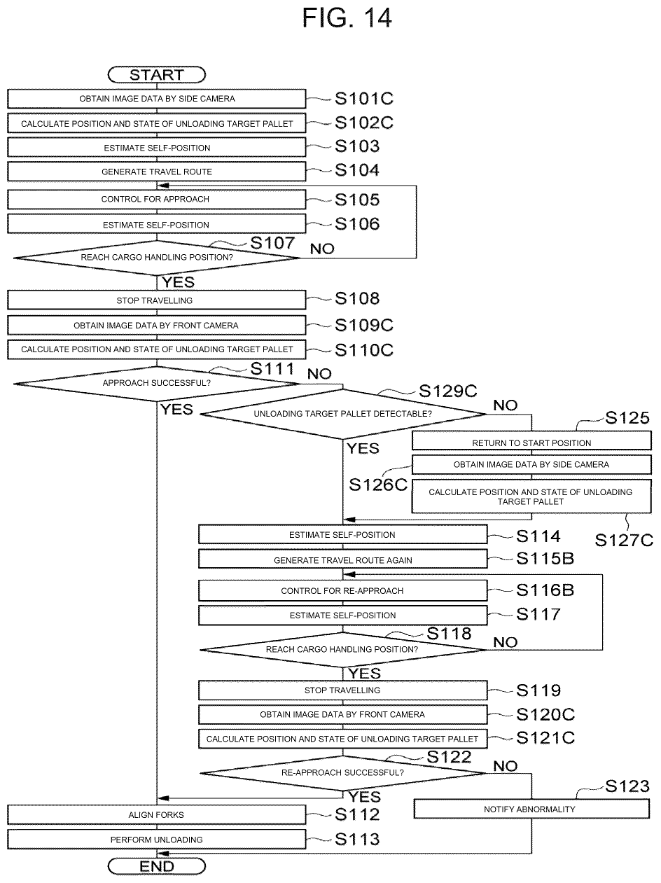

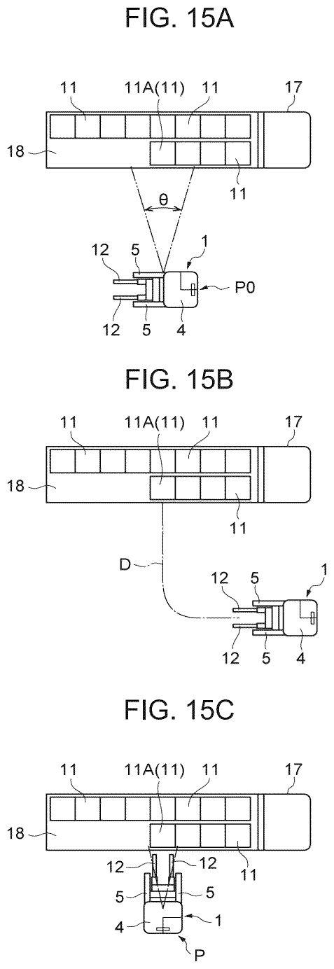

FIG. 14 is a flowchart of unloading control processing performed by the controller 30C and corresponds to FIG. 11. This processing is executed when the forklift truck 1 reaches the start position P0, as illustrated in FIG. 15A. When the forklift truck 1 reaches the start position P0, the side of the forklift truck 1 faces the unloading target pallet 11A, and the side cameras 51 can recognize the unloading target pallet 11A.

In FIG. 14, the controller 30C firstly obtains the image data by the side cameras 51 (step S101C). Subsequently, the controller 30C calculates the position and the state of the unloading target pallet 11A based on the image data by the side cameras 51 (step S102C). Then, the controller 30C executes steps S103 to S108 in the same manner as the above-described third embodiment.

After step S108 is executed, the controller 30C obtains the image data by the front camera 52 (step S109C). Then, the controller 30C calculates the position and the state of the unloading target pallet 11A based on the image data by the front camera 52 (step S110C). Next, the controller 30C executes step S111 in the same manner as the above-described third embodiment.

When the controller 30C determines in step S111 that the approach of the forklift truck 1 to the cargo handling position P is unsuccessful, the controller 30C determines whether or not the front camera 52 can detect the unloading target pallet 11A at the cargo handling position P based on the position and the state of the unloading target pallet 11A relative to the forklift truck 1 calculated in step S110C (step S129C).

When the controller 30C determines that the front camera 52 can detect the unloading target pallet 11A at the cargo handling position P, the controller 30C executes steps S114 to S119 in the same manner as the above-described third embodiment.

When the controller 30C determines that the front camera 52 cannot detect the unloading target pallet 11A at the cargo handling position P, the controller 30C executes step S125 and then obtains image data by the side cameras 51 (step S126C). Then, the controller 30C calculates the position and the state of the unloading target pallet 11A based on the image data by the side cameras 51 (step S127C). Then, the controller 30C executes steps S114 to S119 in the same manner as the above-described third embodiment.

After step S119 is executed, the controller 30C obtains the image data by the front camera 52 (step S120C). Then, the controller 30C calculates the position and the state of the unloading target pallet 11A based on the image data by the front camera 52 (step S121C). Then, the controller 30C executes step S122 and the subsequent steps in the same manner as the above-described third embodiment.

Here, the pallet position calculator 31C executes steps S101C, S102C, S109C, S110C, S126C, S127C, S120C, and S121C. The self-position estimator 32 executes steps S103, S106, S114, and S117. The route generator 33 executes step S104. The guidance controller 34 executes steps S105, S107, and S108. The approach determiner 35 executes step S111. The detection determiner 42C executes step S129C. The retreat controller 41 executes step S125. The re-route generator 36B executes step S115B. The re-guidance controller 37B executes steps S116B, S118, and S119. The re-approach determiner 38 executes step S122. The cargo handling controller 39 executes steps S112 and S113. The alarm controller 40 executes step S123.

In the cargo handling control device 20C having the above-described configuration, the forklift truck 1 travels straight along the front-rear direction of the truck 17 on one side (on the right side in the illustration) of the truck 17, as illustrated in FIG. 15A. Then, when the forklift truck 1 reaches the start position P0 at which the side of the forklift truck 1 faces the unloading target pallet 11A, the forklift truck 1 temporarily stops travelling.

In this state, the side cameras 51 capture an image of the unloading target pallet 11A. Then, based on the image data by the side cameras 51, the position and the state of the unloading target pallet 11A relative to the forklift truck 1 are calculated, and the travel route D to the cargo handling position P corresponding to the position of the unloading target pallet 11A is generated. At this time, as illustrated in FIG. 15B, the travel route D is generated such that the forklift truck 1 travels backward for a certain distance and then travels forward while turning right toward the cargo handling position P. Then, the forklift truck 1 approaches the cargo handling position P along the travel route D.

As illustrated in FIG. 15C, when the forklift truck 1 reaches the cargo handling position P, an image of the unloading target pallet 11A is captured by the front camera 52. Then, based on the image data by the front camera 52, the position and the state of the unloading target pallet 11A relative to the forklift truck 1 are calculated, and whether or not the approach of the forklift truck 1 to the cargo handling position P is successful is determined.

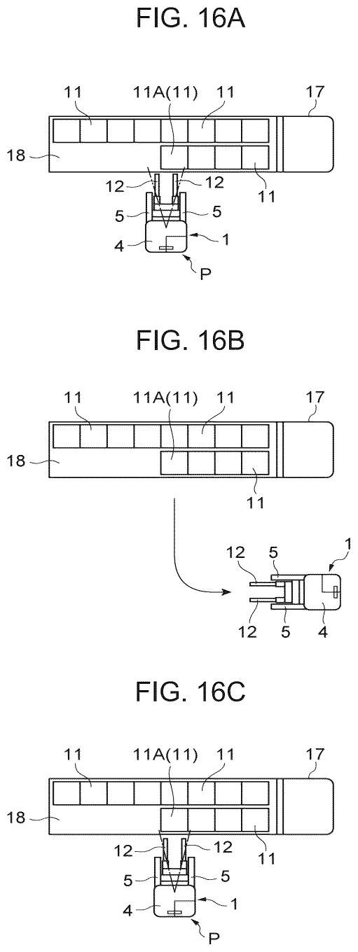

When the approach of the forklift truck 1 to the cargo handling position P is unsuccessful, if the unloading target pallet 11A is detectable by the front camera 52, as illustrated in FIG. 16A, a travel route to the cargo handling position P is generated again. At this time, as shown in FIG. 16B, the travel route is generated such that the forklift truck 1 once travels backward while turning right relative to the cargo handling position P, and then travels forward while turning right toward the cargo handling position P again. Then, as illustrated in FIG. 16C, the forklift truck 1 re-approaches the cargo handling position P along the travel route.

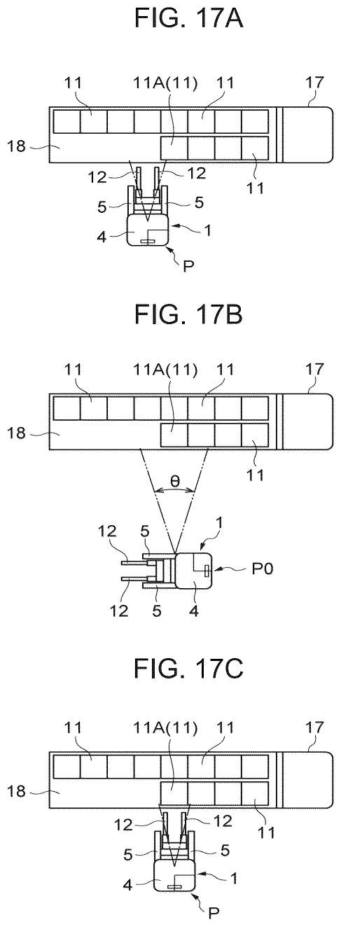

When the approach of the forklift truck 1 to the cargo handling position P is unsuccessful, if the front camera 52 cannot detect the unloading target pallet 11A, as illustrated in FIG. 17A, the forklift truck 1 returns to the start position P0. At this time, the forklift truck 1 reaches the start position P0 by traveling backward relative to the cargo handling position P while turning right and then traveling forward as shown in FIG. 17B.

Then, an image of the unloading target pallet 11A is captured again by the side cameras 51. Based on the image data by the side cameras 51, the position and the state of the unloading target pallet 11A relative to the forklift truck 1 are calculated, and the travel route to the cargo handling position P is generated again. Then, as illustrated in FIG. 17C, the forklift truck 1 re-approaches the cargo handling position P along the travel route.

As described above, in the present embodiment, when the forklift truck 1 is at the start position P0, the side cameras 51 detect the unloading target pallet 11A in a state in which the side of the forklift truck 1 faces the unloading target pallet 11A. Then, the forklift truck 1 is controlled so that the forklift truck 1 approaches the cargo handling position P. As a result, even if a space in front of the unloading target pallet 11A is narrow, the forklift truck 1 can travel to the cargo handling position P corresponding to the unloading target pallet 11A and perform cargo handling.

It is noted that the controller 30C executes processing corresponding to processing executed by the controller 30B of the above-described third embodiment in the present embodiment, but the controller 30C may execute processing corresponding to processing executed by the controller 30 of the first embodiment or executed by the controller 30A of the second embodiment.

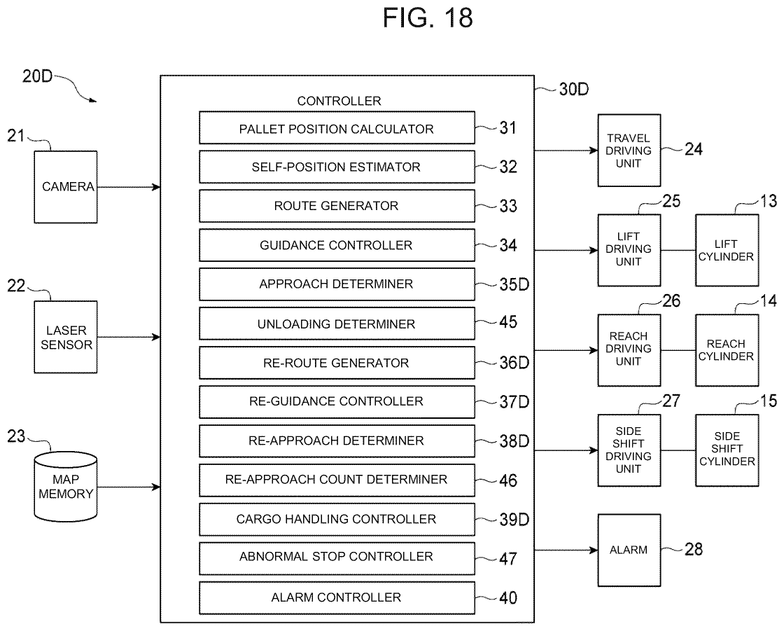

FIG. 18 is a block diagram illustrating a configuration of a cargo handling control device 20D according to a fifth embodiment of the present disclosure. As illustrated in FIG. 18, the cargo handling control device 20D of the present embodiment includes a controller 30D in place of the controller 30 of the first embodiment.

The controller 30D includes the pallet position calculator 31, the self-position estimator 32, the route generator 33, the guidance controller 34, an approach determiner 35D, an unloading determiner 45, a re-route generator 36D, a re-guidance controller 37D, a re-approach determiner 38D, a re-approach count determiner 46, a cargo handling controller 39D, an abnormal stop controller 47, and the alarm controller 40.

The approach determiner 35D determines whether or not the approach of the forklift truck 1 to the cargo handling position P is successful based on the position and the state of the unloading target pallet 11A relative to the forklift truck 1 calculated by the pallet position calculator 31 when the forklift truck 1 reaches the cargo handling position P.

The approach determiner 35D determines whether or not a first condition that a roll angle of the forklift truck 1 relative to the unloading target pallet 11A is equal to or less than a first predetermined angle, a second condition that a pitch angle of the forklift truck 1 relative to the unloading target pallet 11A is equal to or less than a second predetermined angle, a third condition that the lateral displaced amount of the forklift truck 1 relative to the unloading target pallet 11A is equal to or less than the predetermined amount, and a fourth condition that a yaw angle of the forklift truck 1 relative to the unloading target pallet 11A is equal to or less than a third predetermined angle are satisfied.

When all of the first condition, the second condition, the third condition, and the fourth condition are satisfied, the approach determiner 35D determines that the approach of the forklift truck 1 to the cargo handling position P is successful. When any of the first condition, the second condition, the third condition, and the fourth condition is not satisfied, the approach determiner 35D determines that the approach of the forklift truck 1 to the cargo handling position P is unsuccessful.

When the approach determiner 35D determines that the approach of the forklift truck 1 to the cargo handling position P is unsuccessful, the unloading determiner 45 determines whether or not there is a possibility of successful unloading of the unloading target pallet 11A by the re-approach of the forklift truck 1 to the cargo handling position P based on the position and the state of the unloading target pallet 11A relative to the forklift truck 1 calculated by the pallet position calculator 31 when the forklift truck 1 reaches the cargo handling position P.

When the above first condition and the second condition are satisfied, the unloading determiner 45 determines that there is a possibility of successful unloading of the unloading target pallet 11A by the re-approach of the forklift truck 1 to the cargo handling position P. When any of the first condition and the second condition is not satisfied, the unloading determiner 45 determines that there is no possibility of successful unloading of the unloading target pallet 11A even by the re-approach of the forklift truck 1 to the cargo handling position P.

When the unloading determiner 45 determines that there is a possibility of successful unloading of the unloading target pallet 11A by the re-approach of the forklift truck 1 to the cargo handling position P, the re-route generator 36D generates a travel route to the cargo handling position P again based on the position and the state of the unloading target pallet 11A relative to the forklift truck 1 calculated by the pallet position calculator 31 and the self-position of the forklift truck 1 estimated by the self-position estimator 32 at the cargo handling position P.

The re-guidance controller 37D controls the travel driving unit 24 so that the forklift truck 1 is guided to the cargo handling position P again in accordance with the travel route generated by the re-route generator 36D again based on the self-position of the forklift truck 1 estimated by the self-position estimator 32.

The re-guidance controller 37D, the self-position estimator 32, and the re-route generator 36D cooperate to form a re-approach controller that controls the forklift truck 1 so that the forklift truck 1 re-approaches the cargo handling position P based on the position of the unloading target pallet 11A relative to the forklift truck 1 calculated by the position calculator when the unloading determiner 45 determines that there is a possibility of successful unloading of the unloading target pallet 11A by the re-approach of the forklift truck 1 to the cargo handling position P.

The re-approach controller controls the forklift truck 1 so that the forklift truck 1 re-approaches the cargo handling position P based on the position of the unloading target pallet 11A relative to the forklift truck 1 calculated by the position calculator when the re-approach determiner 38D, which will be described later, determines that the re-approach of the forklift truck 1 to the cargo handling position P is unsuccessful.

The re-approach determiner 38D determines whether or not the re-approach of the forklift truck 1 to the cargo handling position P is successful based on the position and the state of the unloading target pallet 11A relative to the forklift truck 1 calculated by the pallet position calculator 31 when the forklift truck 1 reaches the cargo handling position P again.

The re-approach count determiner 46 determines whether or not the number of times the re-approach of the forklift truck 1 to the cargo handling position P has been performed reaches a predetermined upper limit value when the re-approach determiner 38D determines that the re-approach of the forklift truck 1 to the cargo handling position P is unsuccessful.

When the approach determiner 35D determines that the approach of the forklift truck 1 to the cargo handling position P is successful, the cargo handling controller 39D controls the lift driving unit 25, the reach driving unit 26, and the side shift driving unit 27 so that the unloading target pallet 11A is unloaded. In addition, when the re-approach determiner 38D determines that the re-approach of the forklift truck 1 to the cargo handling position P is successful, the cargo handling controller 39D controls the lift driving unit 25, the reach driving unit 26, and the side shift driving unit 27 so that the unloading target pallet 11A is unloaded.

The abnormal stop controller 47 controls the travel driving unit 24 for the abnormal stop by which the forklift truck 1 stops travelling when the unloading determiner 45 determines that there is no possibility of successful unloading of the unloading target pallet 11A even by the re-approach of the forklift truck 1 to the cargo handling position P. In addition, the abnormal stop controller 47 controls the travel driving unit 24 for the abnormal stop by which the forklift truck 1 stops travelling when the re-approach count determiner 46 determines that the number of times the re-approach of the forklift truck 1 to the cargo handling position P has been performed reaches the predetermined upper limit value.

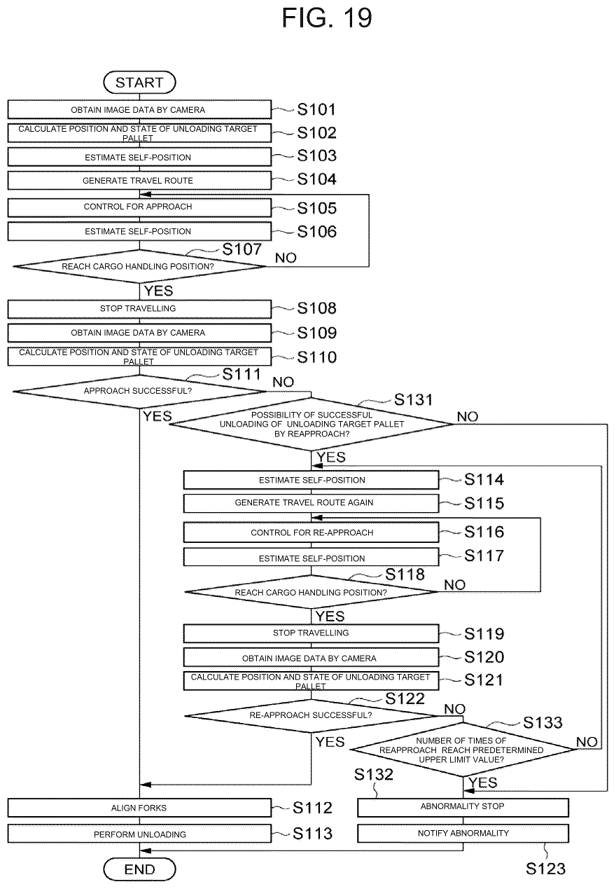

FIG. 19 is a flowchart of unloading control processing performed by the controller 30D and corresponds to FIG. 4.

In FIG. 19, the controller 30D executes steps S101 to S111 in the same manner as the above-described first embodiment. When the controller 30D determines in step S111 that the approach of the forklift truck 1 to the cargo handling position P is successful, the controller 30D executes the above steps S112 and S113.

When the controller 30D determines in step S111 that the approach of the forklift truck 1 to the cargo handling position P is unsuccessful, the controller 30D determines whether or not there is a possibility of successful unloading of the unloading target pallet 11A by the re-approach of the forklift truck 1 to the cargo handling position P based on the position and the state of the unloading target pallet 11A relative to the forklift truck 1 calculated in step S110 (step S131).

Here, a case where unloading of the unloading target pallet 11A becomes unsuccessful includes a pattern in which the success rate of unloading is increased by the re-approach (retry of the approach) of the forklift truck 1 to the cargo handling position P and a pattern in which the success rate of unloading is not increased by the re-approach (retry of the approach) of the forklift truck 1 to the cargo handling position P.

The pattern in which the success rate of unloading is increased by retrying the approach of the forklift truck 1 occurs when there is an error in the self-position estimation or an error in the guidance of the forklift truck 1, as illustrated in FIG. 20A, and is in a state where the forklift truck 1 is not in a position and a state in which the unloading of the unloading target pallet 11A can be performed. The state where the forklift truck 1 is not in the position and the state in which the unloading of the unloading target pallet 11A can be performed occurs when a lateral displaced amount (the displaced amount in the Y-axis direction) of the forklift truck 1 relative to the unloading target pallet 11A is large, and when the yaw angle (the tilt angle around the Z-axis) of the forklift truck 1 relative to the unloading target pallet 11A is large.

On the other hand, the pattern in which the success rate of unloading is not increased even by retrying the approach of the forklift truck 1 is a state where unloading of the unloading target pallet 11A fails even if the forklift truck 1 travels along an ideal route to reach the front of the unloading target pallet 11A because the loading platform 18 of the truck 17 or the unloading target pallet 11A itself is tilted, as illustrated in FIG. 20B. The state where unloading of the unloading target pallet 11A fails even if the forklift truck 1 travels along an ideal route to reach the front of the unloading target pallet 11A occurs when the roll angle (the tilt angle around the X-axis) of the forklift truck 1 relative to the unloading target pallet 11A is large, and when the pitch angle (the tilt angle around the Y-axis) of the forklift truck 1 relative to the unloading target pallet 11A is large.

The displaced amount of the forklift truck 1 relative to the unloading target pallet 11A in the X-axis direction can be offset by changing the position of the forks 12 in the front-rear direction by the reach cylinder 14, or by changing the position of the forks 12 in the front-rear direction by moving the forklift truck 1 forward and backward. The displaced amount of the forklift truck 1 relative to the unloading target pallet 11A in the Z-axis direction can be offset by changing the height position of the forks 12 by the lift cylinder 13.

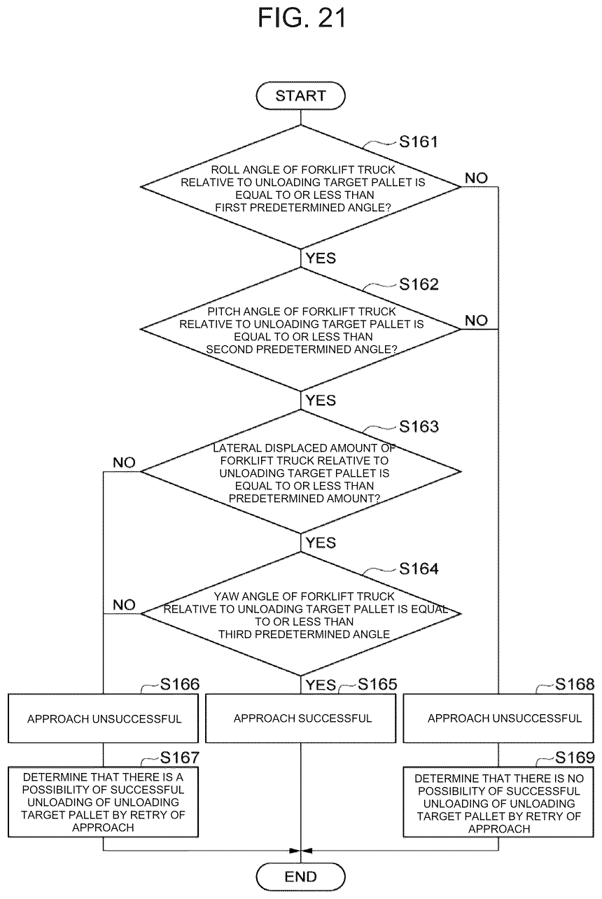

FIG. 21 is a flowchart showing details of steps S111 and S131 shown in FIG. 19.

In FIG. 21, the controller 30D first determines whether or not the roll angle of the forklift truck 1 relative to the unloading target pallet 11A is equal to or less than a first predetermined angle θx based on the state of the unloading target pallet 11A relative to forklift truck 1 obtained in step S110 (step S161). In other words, the controller 30D determines whether or not the first condition that the roll angle of the forklift truck 1 relative to the unloading target pallet 11A is equal to or less than the first predetermined angle θx is satisfied.

The first predetermined angle θx is set to an angle at which the forks 12 can be inserted into the fork holes 11a of the unloading target pallet 11A when the forklift truck 1 is tilted relative to the unloading target pallet 11A in the X-axis direction (see FIG. 22B).

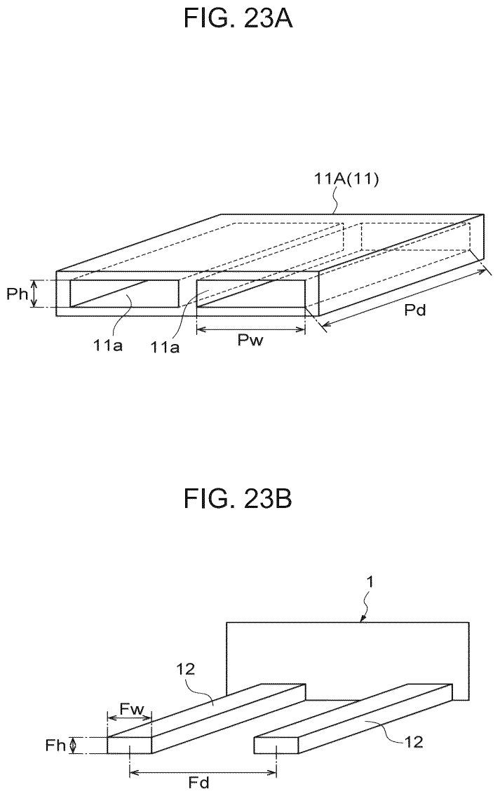

Specifically, when the roll angle of the forklift truck 1 relative to unloading target pallet 11A is greater than the first predetermined angle θx, which is represented by the following Expression 1 where Fw is a width of each of the forks 12, Fd is a distance between the centers of the two forks 12, Fh is a thickness of each of the forks 12, and Ph is a height of each of the fork holes 11a of the unloading target pallet 11A, as illustrated in FIGS. 23A and 23B, the forks 12 cannot be inserted into the fork holes 11a of the unloading target pallet 11A.

$$\vert {θ}_{x} \vert > arcsin ( \frac{{P}_{h}}{\sqrt{{( {F}_{1} + {F}_{w} )}^{2} + {F}_{h}^{2}}} ) - arctan ( \frac{{F}_{h}}{{F}_{1} + {F}_{w}} ) \qquad [ Expression 1 ]$$

When the controller 30D determines that the roll angle of the forklift truck 1 relative to the unloading target pallet 11A is equal to or less than the first predetermined angle θx, the controller 30D determines whether or not the pitch angle of the forklift truck 1 relative to the unloading target pallet 11A is equal to or less than a second predetermined angle θy based on the state of the unloading target pallet 11A relative to forklift truck 1 (step S162). In other words, the controller 30D determines whether or not the second condition that the pitch angle of the forklift truck 1 relative to the unloading target pallet 11A is equal to or less than the second predetermined angle θy is satisfied.

The second predetermined angle θy is set to an angle at which the forks 12 inserted into the fork holes 11a of the unloading target pallet 11A do not interfere with an inner wall of the unloading target pallet 11A when the forklift truck 1 is tilted relative to the unloading target pallet 11A around the Y-axis (see FIG. 22C).

Specifically, when the pitch angle of the forklift truck 1 relative to unloading target pallet 11A is greater than the second predetermined angle θy, which is represented by the following Expression 2 where Fh is the thickness of each of the forks 12, Ph is the height of each of the fork holes 11a of the unloading target pallet 11A, and Pd is a depth of each of the fork holes 11a, as illustrated in FIGS. 23A and 23B, the forks 12 inserted into the fork holes 11a of the unloading target pallet 11A interfere with the inner wall of the unloading target pallet 11A.

$$\vert {θ}_{y} \vert > arctan ( \frac{{P}_{h}}{{P}_{d}} ) - arctan ( \frac{{F}_{h}}{\sqrt{{P}_{h}^{2} + {P}_{d}^{2}}} ) \qquad [ Expression 2 ]$$

When the controller 30D determines that the pitch angle of the forklift truck 1 relative to the unloading target pallet 11A is equal to or less than the second predetermined angle θy, the controller 30D determines whether or not the lateral displaced amount of the forks 12 relative to the unloading target pallet 11A is equal to or less than a predetermined amount J based on the position of the unloading target pallet 11A relative to the forklift truck 1 (step S163). In other words, the controller 30D determines whether or not the third condition that the lateral displaced amount of the forklift truck 1 relative to the unloading target pallet 11A is equal to or less than the predetermined amount J is satisfied.

The predetermined amount J is a value that does not exceed the maximum side shift amount of the forks 12 by the side shift cylinder 15. When the center position of the unloading target pallet 11A exceeds the maximum side shift amount of the forks 12 by the side shift cylinder 15, the lateral displaced amount of the forks 12 relative to the unloading target pallet 11A is greater than the predetermined amount J (see FIG. 22A).

When the controller 30D determines that the lateral displaced amount of the forks 12 relative to the unloading target pallet 11A is equal to or less than the predetermined amount J, the controller 30D determines whether or not the yaw angle of the forks 12 relative to the unloading target pallet 11A is equal to or less than a third predetermined angle θz based on the state of the unloading target pallet 11A relative to forklift truck 1 (step S164). In other words, the controller 30D determines whether or not the fourth condition that the yaw angle of the forklift truck 1 relative to the unloading target pallet 11A is equal to or less than the third predetermined angle θz is satisfied.

The third predetermined angle θz is set to an angle at which the forks 12 inserted into the fork holes 11a of the unloading target pallet 11A do not interfere with the inner wall surfaces of the unloading target pallet 11A when the forklift truck 1 is tilted relative to the unloading target pallet 11A around the Z-axis (see FIG. 22D).

Specifically, when the yaw angle of the forklift truck 1 relative to unloading target pallet 11A is greater than the third predetermined angle θz, which is represented by the following Expression 3 where Fw is the width of each of the forks, Pw is the width of each of the fork holes 11a of the unloading target pallet 11A, and Pd is the depth of each of the fork holes 11a, as illustrated in FIGS. 23A and 23B, the forks 12 inserted into the fork holes 11a of the unloading target pallet 11A interfere with the inner wall of the target pallet 11A.

$$\vert {θ}_{z} \vert > arctan ( \frac{{P}_{w}}{{P}_{d}} ) - arcsin ( \frac{{F}_{w}}{\sqrt{{P}_{w}^{2} + {P}_{d}^{2}}} ) \qquad [ Expression 3 ]$$

The controller 30D determines that the approach of the forklift truck 1 to the cargo handling position P is successful when the yaw angle of the forks 12 relative to the unloading target pallet 11A is equal to or less than the third predetermined angle θz (step S165). Then, the controller 30D executes step S112 of FIG. 19.

When the controller 30D determines in step S163 that the lateral displaced amount of the forks 12 relative to the unloading target pallet 11A is greater than the predetermined amount J, or the controller 30D determines in step S164 that the yaw angle of the forks 12 relative to the unloading target pallet 11A is greater than the third predetermined angle θz, the controller 30D determines that the approach of the forklift truck 1 to the cargo handling position P is unsuccessful (step S166).

In this case, the controller 30D determines that the there is a possibility of successful unloading of the unloading target pallet 11A by the re-approach (retry of the approach) of the forklift truck 1 to the cargo handling position P (step S167). Then, the controller 30D executes step S114 of FIG. 19.

When the controller 30D determines in step S161 that the roll angle of the forklift truck 1 relative to the unloading target pallet 11A is greater than the first predetermined angle θx, or the controller 30D determines in step S162 that the pitch angle of the forklift truck 1 relative to the unloading target pallet 11A is greater than the second predetermined angle θy, the controller 30D determines that the approach of the forklift truck 1 to the cargo handling position P is unsuccessful (step S168).

In this case, the controller 30D determines that there is no possibility of successful unloading of the unloading target pallet 11A even by the re-approach (retry of the approach) of the forklift truck 1 to the cargo handling position P (step S169). Then, the controller 30D executes step S132 of FIG. 19, which will be described later.

Here, step S111 of FIG. 19 corresponds to steps S161 to S166, and S168. Step S131 of FIG. 19 corresponds to steps S161 to S164, S167, and S169.

Returning to FIG. 19, the controller 30D executes steps S114 to S122 when controller 30D determines in step S131 that there is a possibility of successful unloading of the unloading target pallet 11A by the re-approach of the forklift truck 1 to the cargo handling position P. The details of the step S122 are the same as those of step S111 described above.

Then, when the controller 30D determines in step S131 that there is no possibility of successful unloading of the unloading target pallet 11A even by the re-approach of the forklift truck 1 to the cargo handling position P, the controller 30D controls the travel driving unit 24 for the abnormal stop by which the forklift truck 1 stops travelling (step S132). Then, the controller 30D executes step S123.

The controller 30D determines whether or not the number of times the re-approach of the forklift truck 1 to the cargo handling position P has been performed (the number of retries) reaches the predetermined upper limit value when the controller 30D determines in step S122 that the re-approach of the forklift truck 1 to the cargo handling position P is unsuccessful (step S133). The upper limit value may be once as in the first embodiment or a plurality of times. When the controller 30D determines that the number of times the re-approach of the forklift truck 1 to the cargo handling position P has been performed has not reached the upper limit, the controller 30D executes the above step S114 again.

The controller 30D controls the travel driving unit 24 for the abnormal stop by which the forklift truck 1 stops travelling when the controller 30D determines that the number of times the re-approach of the forklift truck 1 to the cargo handling position P has been performed reaches the predetermined upper limit value (step S132). Then, the controller 30D executes step S123.

Here, the pallet position calculator 31 executes steps S101, S102, S109, S110, S120, and S121. The self-position estimator 32 executes steps S103, S106, S114, and S117. The route generator 33 executes step S104. The guidance controller 34 executes steps S105, S107, and S108. The approach determiner 35D executes step S111. The unloading determiner 45 executes step S131. The re-route generator 36D executes step S115. The re-guidance controller 37D executes steps S116, S118, and S119. The re-approach determiner 38D executes step S122. The re-approach count determiner 46 executes step S133. The cargo handling controller 39D executes steps S112 and S113. The abnormal stop controller 47 executes step S132. The alarm controller 40 executes step S123.

In a case where the success rate of unloading increases, it is possible to reduce the number of abnormal procedures and shorten the cycle time of unloading by performing the retry of the approach of the forklift truck 1 to the cargo handling position P. However, when the retry of the approach of the forklift truck 1 to the cargo handling position P is performed even if the success rate of unloading is not increased, the abnormal procedure is delayed by the time of performing the retry of the approach of the forklift truck 1 as compared to the case where the forklift truck 1 is immediately stopped by the abnormal stop control, so that the cycle time for unloading is increased.

In the present embodiment, when it is determined that the approach of the forklift truck 1 to the cargo handling position P is unsuccessful, whether or not there is a possibility of successful unloading of the unloading target pallet 11A by the re-approach of the forklift truck 1 to the cargo handling position P is determined. When it is determined that there is no possibility of successful unloading of the unloading target pallet 11A by the re-approach of the forklift truck 1 to the cargo handling position P, the forklift truck 1 stops travelling by the abnormal stop control, so that the retry of the approach of the forklift truck 1 is not performed unnecessarily. Therefore, the total of time for the abnormal procedure and time for cargo handling is reduced.

In the present embodiment, when the position or the state of the unloading target pallet 11A relative to the forklift truck 1 is displaced by a certain amount or greater, it is determined that the approach of the forklift truck 1 to the cargo handling position P is unsuccessful. Thus, success or failure of the approach of the forklift truck 1 to the cargo handling position P is appropriately determined.

In addition, in the present embodiment, for example, when the roll angle of the forklift truck 1 relative to the unloading target pallet 11A exceeds the first predetermined angle θx or the pitch angle of the forklift truck 1 relative to the unloading target pallet 11A exceeds the second predetermined angle θy due to the tiling of the unloading target pallet 11A, the retry of the approach of the forklift truck 1 is not performed unnecessarily.

In the present embodiment, if the re-approach of the forklift truck 1 to the cargo handling position P is unsuccessful, the probability of the forklift truck 1 reaching the appropriate cargo handling position P corresponding to the position of the unloading target pallet 11A is increased by retrying the approach of the forklift truck 1 to the cargo handling position P again. As a result, the success rate of unloading by forklift truck 1 is further increased.

In addition, in the present embodiment, when the number of retries of the approach of the forklift truck 1 to the cargo handling position P reaches the upper limit value, the retry of the approach of the forklift truck 1 is not performed unnecessarily by the abnormality stop control of the forklift truck 1. Therefore, the total of time for the abnormal procedure and time for cargo handling is further reduced.

It is noted that the controller 30D executes processing corresponding to processing executed by the controller 30 of the above-described first embodiment in the present embodiment, but the controller 30D may execute processing corresponding to processing executed by the controllers 30A to 30C of the second to fourth embodiments.

Although the embodiments of the present disclosure have been described above, the present disclosure is not limited to the above embodiments. For example, in the above-described second to fourth embodiments, when the approach of the forklift truck 1 to the cargo handling position P is unsuccessful, the forklift truck 1 retreats once from the cargo handling position P to the start position P0, but it is not limited to thereto. The forklift truck 1 only has to retreat once to a position away from the cargo handling position P.

In addition, in the above embodiments, the pallets 11 loaded on the loading platform 18 of the truck 17 are to be unloaded, but it is not limited thereto. For example, the pallets 11 loaded on a truck berth or a designated floor surface may be unloaded.

In addition, although unloading of the pallets 11 is performed as cargo handling in the above embodiments, cargo handling is not limited to the unloading. Cargo handling may be loading in which the pallet 11 held by the forks 12 of the forklift truck 1 is placed on the loading platform 18 of the truck 17.

In addition, in the above embodiments, the position and the state of the unloading target pallet 11A relative to the forklift truck 1 are calculated based on the image data by the camera 21, the side cameras 51, and the front camera 52, but it is not limited thereto. Only the position of the unloading target pallet 11A relative to the forklift truck 1 may be calculated.

In addition, although the unloading target pallet 11A is detected by the camera 21, the side cameras 51, and the front camera 52 in the above embodiments, the target detector that detects the cargo handling target is not particularly limited to a camera. For example, a laser sensor, an ultrasonic sensor, or a light sensor may be used as the target detector.

Although the forklift truck 1 is a reach type forklift truck in the above embodiments, the forklift truck 1 may be a counter type forklift truck. In this case, when unloading is performed, the forks 12 are inserted into the fork holes 11a of the unloading target pallet 11A by moving the forklift truck 1 forward.

In addition, although the forklift truck 1 includes the side shift cylinder 15 in the above embodiments, the present disclosure is also applicable to a forklift truck that is not equipped with the side shift cylinder 15.

What is claimed is:

1. A cargo handling control device that moves a forklift truck from a start position to a cargo handling target and performs cargo handling, the cargo handling control device comprising:
a target detector configured to detect the cargo handling target;
a position calculator configured to calculate a position of the cargo handling target relative to the forklift truck based on detection data by the target detector;
an approach controller configured to control the forklift truck based on the position of the cargo handling target relative to the forklift truck calculated by the position calculator while the forklift truck is at the start position so that the forklift truck approaches a cargo handling position corresponding to the cargo handling target;
an approach determiner configured to determine whether an approach of the forklift truck to the cargo handling position is successful based on the position of the cargo handling target relative to the forklift truck calculated by the position calculator when the forklift truck reaches the cargo handling position;
a cargo handling controller configured to control the forklift truck so that the forklift truck performs cargo handling of the cargo handling target when the approach determiner determines that the approach of the forklift truck to the cargo handling position is successful; and
a re-approach controller configured to control the forklift truck so that the forklift truck re-approaches the cargo handling position based on the position of the cargo handling target relative to the forklift truck calculated by the position calculator when the approach determiner determines that the approach of the forklift truck to the cargo handling position is unsuccessful.

2. The cargo handling control device according to claim 1, wherein
when the approach determiner determines that the approach of the forklift truck to the cargo handling position is unsuccessful, the re-approach controller controls the forklift truck so that the forklift truck retreats once from the cargo handling position and re-approaches the cargo handling position based on the position of the cargo handling target relative to the forklift truck calculated by the position calculator while the forklift truck is at the cargo handling position.

3. The cargo handling control device according to claim 1, wherein
the re-approach controller controls the forklift truck so that the forklift truck retreats once from the cargo handling position, and then controls the forklift truck so that the forklift truck re-approaches the cargo handling position based on the position of the cargo handling target relative to the forklift truck calculated by the position calculator when the approach determiner determines that the approach of the forklift truck to the cargo handling position is unsuccessful.

4. The cargo handling control device according to claim 3, wherein
the re-approach controller controls the forklift truck so that the forklift truck retreats once from the cargo handling position to the start position, and then controls the forklift truck so that the forklift truck re-approaches the cargo handling position based on the position of the cargo handling target relative to the forklift truck calculated by the position calculator while the forklift truck is at the start position.

5. The cargo handling control device according to claim 1, further comprising
a detection determiner configured to determine whether the cargo handling target is detectable by the target detector at the cargo handling position when the approach determiner determines that the approach of the forklift truck to the cargo handling position is unsuccessful, wherein
the re-approach controller controls the forklift truck so that the forklift truck retreats once from the cargo handling position and re-approaches the cargo handling position based on the position of the cargo handling target relative to the forklift truck calculated by the position calculator while the forklift truck is at the cargo handling position when the detection determiner determines that the cargo handling target is detectable by the target detector at the cargo handling position, and
the re-approach controller controls the forklift truck so that the forklift truck retreats once from the cargo handling position, and then controls the forklift truck so that the forklift truck re-approaches the cargo handling position based on the position of the cargo handling target relative to the forklift truck calculated by the position calculator when the detection determiner determines that the cargo handling target is not detectable by the target detector at the cargo handling position.

6. The cargo handling control device according to claim 5, wherein
the re-approach controller controls the forklift truck so that the forklift truck retreats once from the cargo handling position to the start position, and then controls the forklift truck so that the forklift truck re-approaches the cargo handling position based on the position of the cargo handling target relative to the forklift truck calculated by the position calculator while the forklift truck is at the start position when the detection determiner determines that the cargo handling target is not detectable by the target detector at the cargo handling position.

7. The cargo handling control device according to claim 1, wherein
the forklift truck includes a side shift cylinder configured to move a fork in a lateral direction of the forklift truck,
the approach determiner determines whether a lateral displaced amount of the forklift truck relative to the cargo handling target is equal to or less than a predetermined amount based on the position of the cargo handling target relative to the forklift truck calculated by the position calculator while the forklift truck is at the cargo handling position,
the approach determiner determines that the approach of the forklift truck to the cargo handling position is successful when the lateral displaced amount of the forklift truck relative to the cargo handling target is equal to or less than the predetermined amount, and
the approach determiner determines that the approach of the forklift truck to the cargo handling position is unsuccessful when the lateral displaced amount of the forklift truck relative to the cargo handling target is not equal to or less than the predetermined amount.

8. The cargo handling control device according to claim 1, further comprising:
a re-approach determiner configured to determine whether the re-approach of the forklift truck to the cargo handling position is successful based on the position of the cargo handling target relative to the forklift truck calculated by the position calculator when the forklift truck reaches the cargo handling position again; and
a notification unit configured to notify an abnormality when the re-approach determiner determines that the re-approach of the forklift truck to the cargo handling position is unsuccessful, wherein
the cargo handling controller control the forklift truck so that the forklift truck performs cargo handling of the cargo handling target when the re-approach determiner determines that the re-approach of the forklift truck to the cargo handling position is successful.

9. The cargo handling control device according to claim 1, wherein
the target detector detects the cargo handling target with a front of the forklift truck facing the cargo handling target.

10. The cargo handling control device according to claim 1, wherein
the target detector includes a first detector configured to detect the cargo handling target with a side of the forklift truck facing the cargo handling target, and a second detector configured to detect the cargo handling target with a front of the forklift truck facing the cargo handling target, and
the position calculator calculates the position of the cargo handling target relative to the forklift truck based on detection data by the first detector when the forklift truck is at the start position, and calculates the position of the cargo handling target relative to the forklift truck based on detection data by the second detector when the forklift truck is at the cargo handling position.

11. The cargo handling control device according to claim 1, wherein
the cargo handling target is a pallet that has a pair of fork holes to which a pair of right and left forks of the forklift truck is inserted,
the position calculator calculates a position and a state of the pallet relative to the forklift truck based on the detection data by the target detector,
the approach controller controls the forklift truck so that the forklift truck approaches the cargo handling position corresponding to the position of the pallet based on the position and the state of the pallet relative to the forklift truck calculated by the position calculator while the forklift truck is at the start position,
the approach determiner determines whether the approach of the forklift truck to the cargo handling position is successful based on the position and the state of the pallet relative to the forklift truck calculated by the position calculator when the forklift truck reaches the cargo handling position,
the cargo handling controller controls the forklift truck so that the forklift truck performs unloading of the pallet as cargo handling when the approach determiner determines that the approach of the forklift truck to the cargo handling position is successful, and
the re-approach controller controls the forklift truck so that the forklift truck re-approaches the cargo handling position based on the position and the state of the pallet relative to the forklift truck calculated by the position calculator when the approach determiner determines that the approach of the forklift truck to the cargo handling position is unsuccessful.

12. The cargo handling control device according to claim 11, further comprising:
an unloading determiner configured to determine, when the approach determiner determines that the approach of the forklift truck to the cargo handling position is unsuccessful, whether there is a possibility of successful unloading of the pallet by the re-approach of the forklift truck to the cargo handling position based on the position and the state of the pallet relative to the forklift truck calculated by the position calculator when the forklift truck reaches the cargo handling position; and
an abnormal stop controller configured to control the forklift truck for an abnormal stop by which the forklift truck stops travelling when the unloading determiner determines that there is no possibility of successful unloading of the pallet even by the re-approach of the forklift truck to the cargo handling position, wherein
the re-approach controller controls the forklift truck so that the forklift truck re-approaches the cargo handling position based on the position and the state of the pallet relative to the forklift truck calculated by the position calculator when the unloading determiner determines that there is a possibility of successful unloading of the pallet by the re-approach of the forklift truck to the cargo handling position.

13. The cargo handling control device according to claim 12, wherein
the forklift truck includes a side shift cylinder configured to move the forks in a lateral direction of the forklift truck,
the approach determiner determines whether a first condition that a roll angle of the forklift truck relative to the pallet is equal to or less than a first predetermined angle, a second condition that a pitch angle of the forklift truck relative to the pallet is equal to or less than a second predetermined angle, a third condition that a lateral displaced amount of the forklift truck relative to the pallet is equal to or less than a predetermined amount, and a fourth condition that a yaw angle of the forklift truck relative to the pallet is equal to or less than a third predetermined angle are satisfied,
the approach determiner determines that the approach of the forklift truck to the cargo handling position is successful when all of the first condition, the second condition, the third condition, and the fourth condition are satisfied, and
the approach determiner determines that the approach of the forklift truck to the cargo handling position is unsuccessful when any of the first condition, the second condition, the third condition, and the fourth condition is not satisfied.

14. The cargo handling control device according to claim 13, wherein
the unloading determiner determines that there is a possibility of successful unloading of the pallet by the re-approach of the forklift truck to the cargo handling position when the first condition and the second condition are satisfied, and determines that there is no possibility of successful unloading of the pallet even by the re-approach of the forklift truck to the cargo handling position when any of the first condition and the second condition is not satisfied.

15. The cargo handling control device according to claim 11, further comprising
a re-approach determiner configured to determine whether the re-approach of the forklift truck to the cargo handling position is successful based on the position and the state of the pallet relative to the forklift truck calculated by the position calculator when the forklift truck reaches the cargo handling position again, wherein
the re-approach controller controls the forklift truck so that the forklift truck re-approaches the cargo handling position based on the position and the state of the pallet relative to the forklift truck calculated by the position calculator when the approach determiner determines that the re-approach of the forklift truck to the cargo handling position is unsuccessful, and
the cargo handling controller controls the forklift truck so that the forklift truck performs unloading of the pallet when the re-approach determiner determines that the re-approach of the forklift truck to the cargo handling position is successful.

16. The cargo handling control device according to claim 15, further comprising:
a re-approach count determiner configured to determine whether number of times the re-approach of the forklift truck to the cargo handling position is performed reaches a predetermined upper limit value when the re-approach determiner determines that the re-approach of the forklift truck to the cargo handling position is unsuccessful, and
an abnormal stop controller configured to control the forklift truck for an abnormal stop by which the forklift truck stops travelling when the re-approach count determiner determines that number of times the re-approach of the forklift truck to the cargo handling position is performed reaches a predetermined upper limit value.
